(19) United States
(12) Patent Application Publication
(10) Pub. No.: US 2025/0217155 A1
(43) Pub. Date: Jul. 3, 2025

(54) EARLY RESTEERING OF MISPREDICTED BRANCHES

(71) Applicant: Intel Corporation, Santa Clara, CA (US)

(72) Inventors: Aniket Deshmukh, Bangalore (IN); Sufiyan Syed, Chennai (IN); Jayesh Gaur, Bangalore (IN); Sreenivas Subramoney, Bangalore (IN)

(21) Appl. No.: 18/401,435

(22) Filed: Dec. 30, 2023

(51) Int. Cl. G06F 9/38

(52) U.S. Cl. CPC G06F 9/3863

(57) ABSTRACT

Techniques for early resteering of a branch misprediction are described. Examples detailed herein use a virtual run-ahead mechanism in the core. On a branch misprediction for an hard-to-predict (H2P) branch, a subset of the backslice of the H2P branch are replayed from the out-of-order engine directly (while the main thread is flushing and restarting execution from the front-end).

### BACKGROUND

Primarily branch (mis) prediction solutions can be divided into the following categories. 1) Improving the branch predictor itself. Hard to predict branches (H2P) are typically data dependent and cannot be predicted easily. 2. Reducing the penalty of branch misprediction flushes. This is a property of the out-of-order pipeline and frequency and continues to be optimized as much as possible. 3. Predication schemes that convert H2P branch prediction to predication replacing control dependency by data dependency. 4. Branch runahead schemes that try to do an early execution of branches and feed the prediction outcome to the branch predictor, overriding any wrong prediction.

### BRIEF DESCRIPTION OF DRAWINGS

Various examples in accordance with the present disclosure will be described with reference to the drawings, in which:

FIG. 1 illustrates an example of code with a mispredicting branch.

FIG. 2 illustrates examples of a core supporting early resteering of mispredicted hard-to-predict branches.

FIGS. 3(A)-(B) illustrate various acts that may be performed in a pre-computation and early clearing of hard-to-predict branches system.

FIG. 4 illustrates an example computing system.

FIG. 5 illustrates a block diagram of an example processor and/or System on a Chip (SoC) that may have one or more cores and an integrated memory controller.

FIG. 6 is a block diagram illustrating a computing system configured to implement one or more aspects of the examples described herein.

FIG. 7A illustrates examples of a parallel processor.

FIG. 7B illustrates examples of a block diagram of a partition unit.

FIG. 7C illustrates examples of a block diagram of a processing cluster within a parallel processing unit.

FIG. 7D illustrates examples of a graphics multiprocessor in which the graphics multiprocessor couples with the pipeline manager of the processing cluster.

FIGS. 8A-8C illustrate additional graphics multiprocessors, according to examples.

FIG. 9 shows a parallel compute system, according to some examples.

FIGS. 10A-10B illustrate a hybrid logical/physical view of a disaggregated parallel processor, according to examples described herein.

FIG. 11(A) is a block diagram illustrating both an example in-order pipeline and an example register renaming, out-of-order issue/execution pipeline according to examples.

FIG. 11(B) is a block diagram illustrating both an example in-order architecture core and an example register renaming, out-of-order issue/execution architecture core to be included in a processor according to examples.

FIG. 12 illustrates examples of execution unit(s) circuitry, such as execution unit(s) circuitry.

FIG. 13 is a block diagram of a register architecture according to some examples.

FIGS. 14A-14B illustrate thread execution logic including an array of processing elements employed in a graphics processor core according to examples described herein.

FIG. 15 illustrates an additional execution unit, according to an example.

FIG. 16 is a block diagram illustrating a graphics processor instruction formats 1600 according to some examples.

FIG. 17 is a block diagram of another example of a graphics processor.

FIG. 18A is a block diagram illustrating a graphics processor command format according to some examples.

FIG. 18B is a block diagram illustrating a graphics processor command sequence according to an example.

FIG. 19 is a block diagram illustrating an IP core development system that may be used to manufacture an integrated circuit to perform operations according to some examples.

### DETAILED DESCRIPTION

The present disclosure relates to methods, apparatus, systems, and non-transitory computer-readable storage media for early resteering of mispredicted hard-to-predict branches.

Branch misprediction and the associated mispredicts constitute a major portion of stalled cycles in modern computing designs. As cores become wider and deeper this problem only gets exacerbated. In some examples, a branch clear is indicated when there is a misprediction. In some examples, a branch clear indication is to cause a front end to fetch and decode down the correct path. In some examples, this branch clear is caused by a jump execution unit branch misprediction when the actual branch is executed. For example, the jump execution unit compares the age of a faulty load instruction identified by the load and/or the early instant reclamation request with ages of other instructions currently being handled by the jump execution unit. For example, the jump execution unit may determine whether any mis-predicted branch instructions are being handled by the out-of-order processor that are older than the faulty load instruction (e.g., the mis-predicted load instruction being handled occurs earlier in program order than the faulty load instruction). The branch misprediction clears all instructions that are after (in program order) a mis-predicted branch instruction. These branch clears reduce possible instruction level parallelism (ILP).

Examples herein describe a pre-computation and early clearing of hard-to-predict branches (PEACH) that belongs to this last category of solutions but addresses a big flaw that plagues these run-ahead schemes—these schemes need long run-ahead so they can override a faulty branch predictor.

Instead of trying to override the branch predictor at fetch, PEACH overrides the branch prediction later in the pipeline up to branch schedule time. This early clear is more power efficient than a full pipeline flush. To accomplish this, examples detailed herein use a virtual run-ahead mechanism in the core. On a branch misprediction for an H2P branch, a subset of the backslice (e.g., the chain leading to the branch) of the H2P branch are replayed from the out-of-order engine directly (while the main thread is flushing and restarting execution from the front-end). This allows for the quick resolving of wrong branches and issuance of a branch misprediction earlier which improves performance.

Note that this approach is different from existing run-ahead or helper thread mechanisms. Current helper thread mechanisms rely on a separate thread (or separate core) to execute run ahead back-slices. This is done because the only mechanism for them is to override the branch predictor.

In some examples, at a high-level, hard to predict (H2P) branch instruction pointers are identified. For every H2P, a backslice (across iterations) is learned and the microops (uops) stored in a separate cache. When a Branch misprediction is seen on an H2P branch, the virtual run-ahead for future H2P branch instances is started using the existing core resources—and is replayed from the cache. The main thread continues to fetch from the front-end on the correct path. As the run-ahead mechanism resolves branches, it overrides the wrong predictions done by the BPU (branch predictor). This can be done as early as at BPU prediction time, or as late as before the actual branch execution. Every cycle saved on branch mis-prediction gives substantial performance.

Branches that mispredict often are usually data dependent branches that cannot be accurately predicted by branch predictors. For example, these branches may take the form of:

```
do:
  if (condition_1) break
  else if (condition_2) continue
  if (condition_3) break
while (condition_4)
```

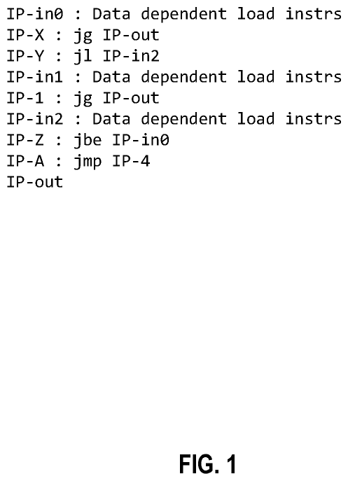

FIG. 1 illustrates an example of code with a mispredicting branch. In this example, the branch at IP-1 (the jump if greater (jg) which is condition_3 above) is a H2P branch and as its dependencies are tracked it becomes clear that this branch depends on long latency loads and, other compute making it clear very often. This means that even if one could accurately predict intermediate loads (which one cannot because the data keeps changing in every instance), front end resteers are all that are available.

Many earlier attempts to solve this problem either created heavy weight helper threads which takes separate core resources or used compiler techniques. These solutions all relied on changing the branch prediction direction. However, examples detailed herein do not override branch predictors because the mechanisms used to execute and check the data dependences is not timely enough. For example, any cycle of saving in the Branch mispredictions yields performance and when the focus is on overriding the branch predictor output, coverage is lost because the data dependence chains are either long (or short even) but the misprediction happens multiple iterations after the last mispredict. This second point indicates that there is enough slack in the system before the next mispredict so that resteering the branch direction will give upside. However, because of the increased width in modern systems this mispredicting instance could have already been fetched and decoded even before the precomputation thread begins which means one cannot rely on overriding the branch direction.

All the way from fetch to after the mispredicting uop has been allocated and is in reservation station waiting for its sources to resolve. Because these H2P branches are data dependent, they can only be pre-computed before they are mispredicted. Using a trigger and then resteering when the pre-computation of the H2p instance shows a difference from what was predicted.

A goal is to reduce the impact of branch mispredictions due to direct conditional branches that are critical, i.e., cause a large performance degradation. The directions of these branches are found by pre-executing these dependence chains either before the branch is fetched (saving a branch misprediction) or after the branch is fetched and before resolution (issuing an early branch misprediction).

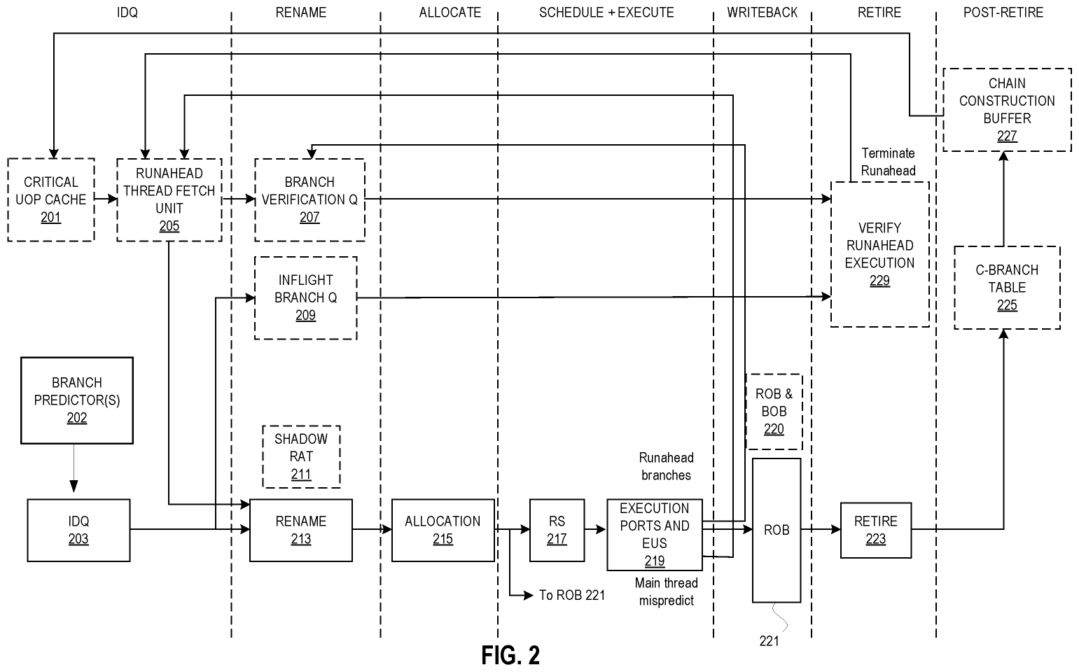

FIG. 2 illustrates examples of a core supporting early resteering of mispredicted hard-to-predict branches. This core is pipelined into several sages. An instruction decode queue stage, a register rename stage, a resource allocation stage, a scheduling and execution stage, a writeback stage, a retirement stage, and a post-retirement stage.

The solid boxes represent components (circuitry) that is typically available in a core. One or more branch predictors 202 try to determine if a branch will be taken or not taken (that is these predictors attempt to determine an execution path based on the branch). In particular, the or more branch predictors 202 determine the next block of code to be executed. A branch prediction predicts the branch target and enables the processor to begin executing instructions long before the branch true execution path is known. The branch predictor(s) 202 predict(s) the target address not only based on the instruction pointer of the branch but also based on the execution path through which execution reached this instruction pointer. The branch predictor(s) 202 predict conditional branches, direct calls and jumps, indirect calls and jumps, and/or returns.

An instruction decode queue 203 stores decoded micro-operations (or operations) to be performed.

Rename circuitry 213 moves micro-operations to the out-of-order engine and renames architectural sources and destinations of the micro-operations (micro-ops or uops) to micro-architectural sources and destinations.

Allocation circuitry 215 allocates resources (e.g., load or store buffers) to the micro-operations.

The reservation station (RS) 217 controls the dispatch of uops onto execution ports 219. The reservation station 217 identifies which micro-ops are ready and where their sources come from: a register file entry, or a bypass directly from an execution unit. When all source operands are ready, the RS 217 schedules and dispatches ready micro-ops to the available execution ports and execution units 219.

A reorder buffer (ROB) 221 holds micro-ops in various stages of completion, buffers completed microops, updates the architectural state in order, and manages ordering of exceptions. In some examples, as a micro-op is renamed, the rename circuitry 213 determines whether a uop's source operands have executed and been written to the ROB 221, or whether they will be captured “in flight” in the RS 217 or in the bypass network.

Retirement circuitry 223 tracks when instructions (micro-ops) are ready to be retired. It retires instructions in program order.

The dashed boxes represent additional components that allow for early resteering of mispredicted hard-to-predict branches.

All retiring uops of the main thread are stored in a chain construction buffer (CCB) 227. Each entry in the chain construction buffer 227 has a single uop, and contains the logical instruction pointer (LIP), uop bytes, source and destination registers, source and destination memory locations, or other uop characteristics including opcode, etc. and a bit to indicate whether this uop is critical.

Mispredicting retiring instructions are added to a critical branch (cbranch) data structure 225 which is an instruction pointer tagged data structure. This critical branch data structure 225 holds all those uops which mispredict the most often. This provides information on which branches need to be precomputed. These uops are stored at retire because they are guaranteed to have a correct path for a backslice of instructions.

Branches that are H2P are marked as critical. In some examples, a set of H2P branches is found using a per-instruction pointer (IP) confidence predictor and branch misprediction slack (heuristic to determine criticality). For static branch confidence, the cbranch data structure 225 which stores those uops which had mispredicted at retire is used. This cbranch data structure 225 is incremented on seeing a mispredict and periodically decremented. The cbranch data structure 225 is augmented with a predictor that identifies only those instances of the critical branches which are likely to mispredict.

For branch criticality, another metric of branch misprediction slack is used. This metric is computed as follows.
A=number of cycles between branch resolution and retire. A measures the amount of slack available for until the branch becomes critical.
B=number of cycles between branch retire and the retire of the next right path instruction after the branch. B measures how long misprediction recovery and re-filling the out-of-order pipeline takes.

Branch Misprediction slack=−B if B>1,A if B<=1

A positive slack indicates that the branch misprediction is likely not on the critical path and the magnitude represents the slack available (in terms of cycles) before the misprediction becomes critical. Even though the branch is mispredicted, it will not decrease performance much as there are enough instructions buffered in the ROB 221 (older than the branch) that do useful work and overlap with the mispred iction flush and pipeline refill latency.

A negative slack measures how much earlier branches must be resolved to eliminate performance degradation due to mispredictions. Most branches have negative slack, and branches with more negative slacks have a larger impact on performance. Note that these numbers are heuristic. A branch misprediction may result in decreased performance even if it has positive slack as an instruction (like a long/medium latency load) fetched several instructions after the misprediction may be on the critical path (and not the first right path instruction after it).

When the chain construction buffer 227 is full, it is iterated over each instruction starting from the youngest. If an instruction is marked critical, then its sources are added to a source list. Any older instructions that write to a register or memory location in the source list are also marked critical. The destinations of these critical uops are then removed from the source list and its sources are added back in. This allows for instructions in the dependence chains leading up to H2P branches to be accurately found. These critical uops are provided to a critical branch uop cache 201 that stores these uops at a basic block granularity tagged with the basic block ID.

Critical branch execution is triggered on a branch misprediction. When a branch mispredicts and flushes the pipeline, the program counter (PC) of the first right path instruction is sent to the critical uop cache 201 from the CCB 227. If a basic block corresponding to this PC is found, critical uops are read out of the cache 201 and the direction of the next H2P branch is pre-computed by a runahead thread fetch unit 205 and are sent to rename 213 as a critical uop (or PEACH) thread. These uops are then subsequently allocated using allocation circuitry 215 in the backend and begin execution (through the reservation station 217 and execution units 219). The uops stop pre-computation if either the computed branch direction is incorrect as determined by the verify runahead execution circuitry 229 which verifies both main thread (e.g., inflight) branches queued in inflight branch queue 209 and PEACH threads or the uops for the next basic block are not present.

Critical uop basic blocks can be fetched assuming a fixed control flow (e.g., executing the same chain over and over). In some examples, critical branch is allowed to finish computation, find its direction and target, and then critical uops from the next basic block are fetched. This allows chaining of various control flows if the corresponding basic blocks are present in the critical uop cache 201.

Chains from different control flow paths can cause problems as the dataflow can change if the branch directions seen when fetching and executing critical uops are different from the directions when recording the chains. In some examples, this is addressed by using a mask per basic block and taking the union of critical instructions seen on all observed control flow paths in some examples.

In some examples, once the branch prediction unit ((BPU) state is fixed (during the flush), BPU predictions can be used to speculative fetch critical basic blocks. While most of these branches are hard to predict, the BPU still provides a high degree prediction accuracy for these branches. Further, a different predictor can tell when BPU predictions are likely to be correct. In these situations, the full branch chain need not be fetched and executed; only the uops needed to compute the loop variables for the iterations that are likely to mispredict need to be computed. If the BPU prediction turns out to be incorrect (as verified by the execution of the critical branch chains), the chains can be partially flushed and re-fetched from the mispredicting branch.

In the absence of a branch predictor, in some examples, predication is used at those intermediate branches so that the system is not starved without any work. The predication may be at multiple levels (such that the first branch seen predicates into its Taken and Not Taken portions and the branches in each of these paths predicates to their own respective Taken and Not Takens and so on for each of the branches on those paths). All the predicated portions of the branches are stored in RS 217 ready to execute as soon as their respective guard branches are resolved.

As core resources (e.g., physical register ports, execution units, etc.) become available, they are scavenged to allocate to critical branch uops (or PEACH thread). The results of the execution except for branch directions (stored in a separate Branch Order Buffer (BOB) 220) are discarded once complete. This may increase the pressure on the out-of-order engine, especially in benchmarks that are backend limited. When an intermediate branch resolves, if it has been predicated, the direction of predication is resolved and the OOO structures that were occupied by the wrong path uops are flushed. The chain of uops tagged are stored with a value to indicate the NT and Taken at each level.

The physical register file (PRF) and reservation station 217 are shared by PEACH threads and the main thread. In some examples, PEACH threads have a separate load buffer and store buffer. In some examples, for all younger loads which are part of the PEACH thread, are compared against the PEACH Store Buffer to find matches and then compared against the main store buffer if there is no match found.

The PEACH thread also has an independent ROB and BOB 220. A copy of the register alias table (RAT) is taken at misprediction (and stored in shadow RAT 211) and the RAT state is recovered to get it to the point of misprediction. This RAT state is used for renaming.

Branches in the peach thread are provided to the branch verification queue 207.

On completion of execution in the PEACH thread, uops are marked as being complete in the PEACH ROB. A pseudo retirement happens in-order with writes to PRF and previous writers to the PRF tagged for reclamation.

Verifying the computation of the critical branch chain using the verify runahead execution circuitry 229 is done by collecting the predictions of all the critical branches (and the directions and targets of other control flow assumptions) when executing the critical branch chains. Each prediction with what is matched with seen in the main thread. Then these predictions are equated with the ones computed by the main thread.

The PEACH chain predictions will cause a branch misprediction if they differ from the BPU 202. If a PEACH chain is incorrect (after verification above), a second branch misprediction (double branch misprediction) is triggered. This happens mostly when there are cold misses in the critical uop cache 201 or otherwise the full path is not available or has memory dependencies that were missed in the previous time when the backslice was built.

The table below illustrates examples of actions based on thread agreement/disagreement on a branch.

| Main thread vs | | |
|---|---|---|
| Peach Thread | Threads agree on branch | Threads disagree on branch |
| Peach Chain | No branch misprediction | Early branch misprediction |
| Correct | indication | indication |
| Peach Chain | Normal branch | Double branch |
| Incorrect | misprediction indication | misprediction indication |

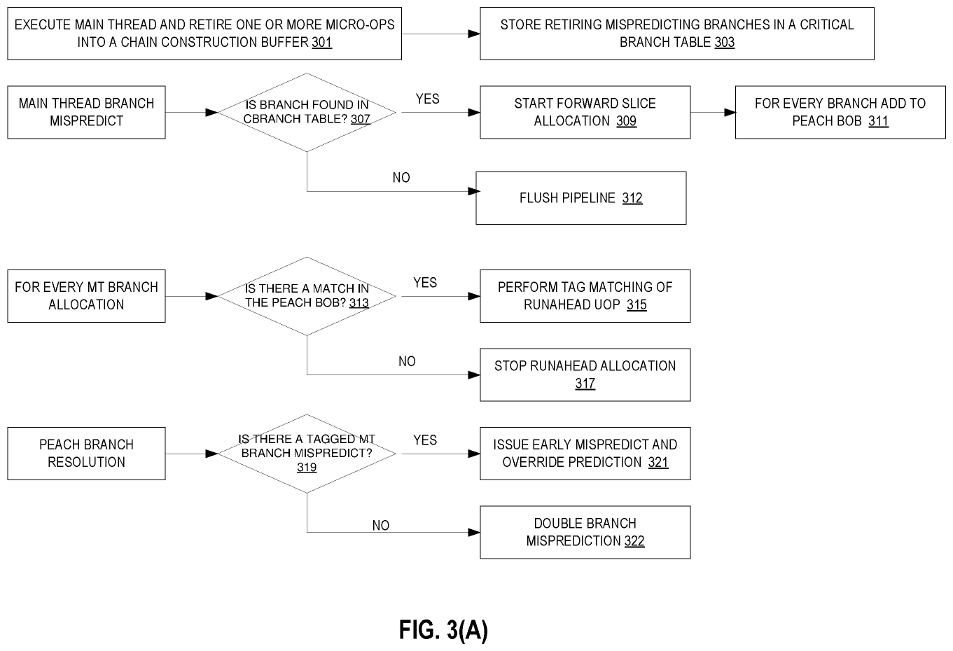

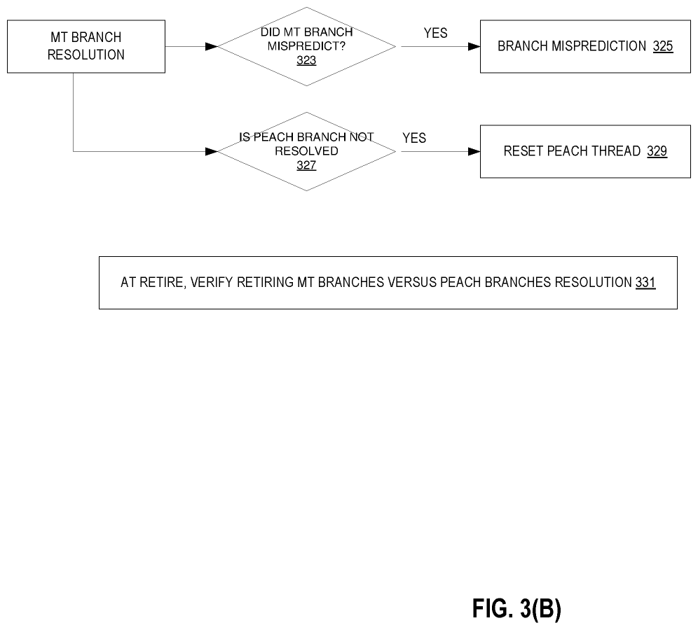

FIGS. 3(A)-(B) illustrate various acts that may be performed in a pre-computation and early clearing of hard-to-predict branches system. Note that the illustration does not necessarily connote an order.

One or more micro-ops are retired into a chain construction buffer at 301 and mispredicting branches are stored in a critical branch table at 301. These are micro-ops and branches of a main (non-virtual runahead) thread.

When the main thread generates a branch misprediction, a determination is made of if the branch that triggered the branch misprediction is found in the critical branch table at 307. If yes, then a forward slice (micro-ops that could be affected by the branch mispredict) allocation is started at 309 and every branch in that forward slice is added to the PEACH BOB (which stores branch directions) at 311. If not, then the pipeline is flushed at 312 as normal (with no runahead).

For every main thread branch allocation, a determination is made of if there is a match in the PEACH BOB at 313. If there is a match, then the branch is a part of a forward slice, and a tag match is performed for a runahead (PEACH) uop at 315 and the PEACH thread can be used. If not, then runahead allocation is stopped at 317 as there is no match in the PEACH thread to that can be used instead of the main thread.

For a PEACH branch resolution, a determination is made of if there is main thread branch misprediction at 319. If yes, an early branch misprediction is issued at 321 that overrides the BPU. This means that there is a correct PEACH thread, but that the main thread and PEACH thread do not agree. If both threads agree, then there is no branch misprediction. If the PEACH thread resolved incorrectly and the main thread was correct, a double branch misprediction occurs-first from the incorrect PEACH resolution and then from the main thread resolving correctly at 322.

At main thread branch resolution, a determination is made of if the main thread branch mispredicted at 323. If yes, and the PEACH thread was also incorrect, then a normal branch misprediction is issued at 325. If however, the PEACH thread branch is not resolved (determined at 327), then the PEACH thread is reset.

At retirement, both main thread and PEACH branches are verified at 331. In some examples, the above determinations are made by one or more of retirement circuitry 223, verify runahead execution circuitry 229, rename circuitry 213, allocation circuitry 215, and/or execution circuitry.

Some examples are implemented in one or more computer architectures, cores, accelerators, etc. Some examples are generated or are IP cores. Some examples utilize emulation and/or translation.

### Example Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

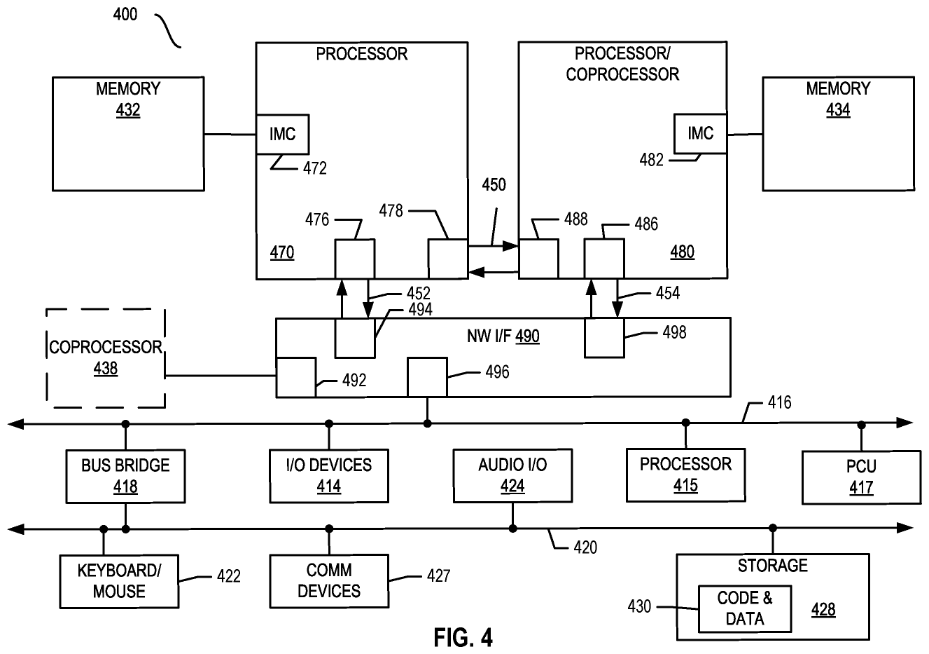

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example multiprocessor system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a co-processor 438 via an interface circuit 492. In some examples, the co-processor 438 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430 and may implement the storage ‘ISAB03 in some examples. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

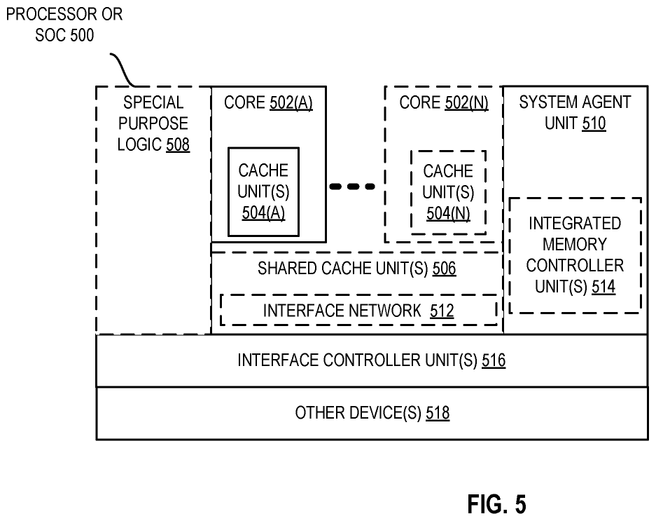

FIG. 5 illustrates a block diagram of an example processor and/or SoC 500 that may have one or more cores and an integrated memory controller. The solid lined boxes illustrate a processor and/or SoC 500 with a single core 502(A), system agent unit circuitry 510, and a set of one or more interface controller unit(s) circuitry 516, while the optional addition of the dashed lined boxes illustrates an alternative processor and/or SoC 500 with multiple cores 502(A)-(N), a set of one or more integrated memory controller unit(s) circuitry 514 in the system agent unit circuitry 510, and special purpose logic 508, as well as a set of one or more interface controller unit(s) circuitry 516. Note that the processor and/or SoC 500 may be one of the processors 470 or 480, or co-processor 438 or 415 of FIG. 4.

Thus, different implementations of the processor and/or SoC 500 may include: 1) a CPU with the special purpose logic 508 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 502(A)-(N) being one or more general purpose cores (e.g., general purpose in-order cores, general purpose out-of-order cores, or a combination of the two); 2) a co-processor with the cores 502(A)-(N) being a large number of special purpose cores intended primarily for graphics and/or scientific (throughput); and 3) a co-processor with the cores 502(A)-(N) being a large number of general purpose in-order cores. Thus, the processor and/or SoC 500 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit(s) circuitry 516 couple the cores 502(A)-(N) to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

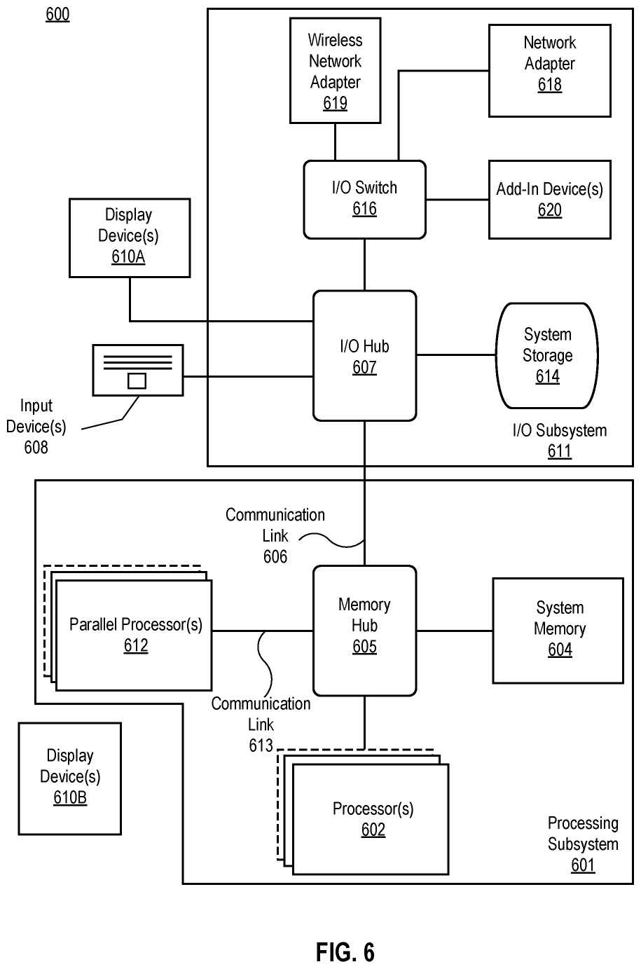

FIG. 6 is a block diagram illustrating a computing system 600 configured to implement one or more aspects of the examples described herein. The computing system 600 includes a processing subsystem 601 having one or more processor(s) 602 and a system memory 604 communicating via an interconnection path that may include a memory hub 605. The memory hub 605 may be a separate component within a chipset component or may be integrated within the one or more processor(s) 602. The memory hub 605 couples with an I/O subsystem 611 via a communication link 606. The I/O subsystem 611 includes an I/O hub 607 that can enable the computing system 600 to receive input from one or more input device(s) 608. Additionally, the I/O hub 607 can enable a display controller, which may be included in the one or more processor(s) 602, to provide outputs to one or more display device(s) 610A. In some examples the one or more display device(s) 610A coupled with the I/O hub 607 can include a local, internal, or embedded display device.

The processing subsystem 601, for example, includes one or more parallel processor(s) 612 coupled to memory hub 605 via a bus or communication link 613. The communication link 613 may be one of any number of standards-based communication link technologies or protocols, such as, but not limited to PCI Express, or may be a vendor specific communications interface or communications fabric. The one or more parallel processor(s) 612 may form a computationally focused parallel or vector processing system that can include a large number of processing cores and/or processing clusters, such as a many integrated core (MIC) processor. For example, the one or more parallel processor(s) 612 form a graphics processing subsystem that can output pixels to one of the one or more display device(s) 610A coupled via the I/O hub 607. The one or more parallel processor(s) 612 can also include a display controller and display interface (not shown) to enable a direct connection to one or more display device(s) 610B.

Within the I/O subsystem 611, a system storage unit 614 can connect to the I/O hub 607 to provide a storage mechanism for the computing system 600. An I/O switch 616 can be used to provide an interface mechanism to enable connections between the I/O hub 607 and other components, such as a network adapter 618 and/or wireless network adapter 619 that may be integrated into the platform, and various other devices that can be added via one or more add-in device(s) 620. The add-in device(s) 620 may also include, for example, one or more external graphics processor devices, graphics cards, and/or compute accelerators. The network adapter 618 can be an Ethernet adapter or another wired network adapter. The wireless network adapter 619 can include one or more of a Wi-Fi, Bluetooth, near field communication (NFC), or other network device that includes one or more wireless radios.

The computing system 600 can include other components not explicitly shown, including USB or other port connections, optical storage drives, video capture devices, and the like, which may also be connected to the I/O hub 607. Communication paths interconnecting the various components in FIG. 6 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 612 may incorporate circuitry optimized for graphics and video processing, including, for example, video output circuitry, and constitutes a graphics processing unit (GPU). Alternatively or additionally, the one or more parallel processor(s) 612 can incorporate circuitry optimized for general purpose processing, while preserving the underlying computational architecture, described in greater detail herein. Components of the computing system 600 may be integrated with one or more other system elements on a single integrated circuit. For example, the one or more parallel processor(s) 612, memory hub 605, processor(s) 602, and I/O hub 607 can be integrated into a system on chip (SoC) integrated circuit. Alternatively, the components of the computing system 600 can be integrated into a single package to form a system in package (SIP) configuration. In some examples at least a portion of the components of the computing system 600 can be integrated into a multi-chip module (MCM), which can be interconnected with other multi-chip modules into a modular computing system.

It will be appreciated that the computing system 600 shown herein is illustrative and that variations and modifications are possible. The connection topology, including the number and arrangement of bridges, the number of processor(s) 602, and the number of parallel processor(s) 612, may be modified as desired. For instance, system memory 604 can be connected to the processor(s) 602 directly rather than through a bridge, while other devices communicate with system memory 604 via the memory hub 605 and the processor(s) 602. In other alternative topologies, the parallel processor(s) 612 are connected to the I/O hub 607 or directly to one of the one or more processor(s) 602, rather than to the memory hub 605. In other examples, the I/O hub 607 and memory hub 605 may be integrated into a single chip. It is also possible that two or more sets of processor(s) 602 are attached via multiple sockets, which can couple with two or more instances of the parallel processor(s) 612.

Some of the particular components shown herein are optional and may not be included in all implementations of the computing system 600. For example, any number of add-in cards or peripherals may be supported, or some components may be eliminated. Furthermore, some architectures may use different terminology for components similar to those illustrated in FIG. 6. For example, the memory hub 605 may be referred to as a Northbridge in some architectures, while the I/O hub 607 may be referred to as a Southbridge.

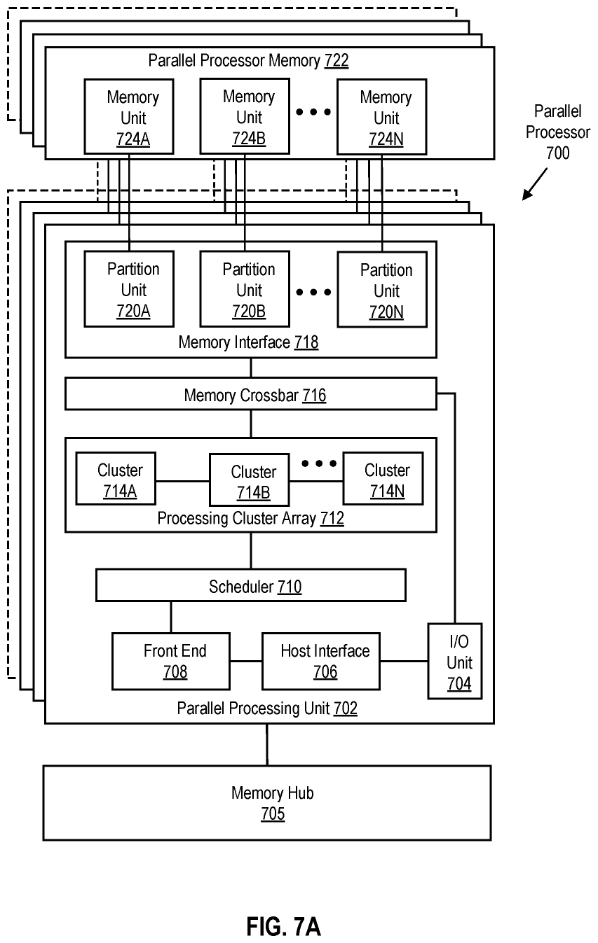

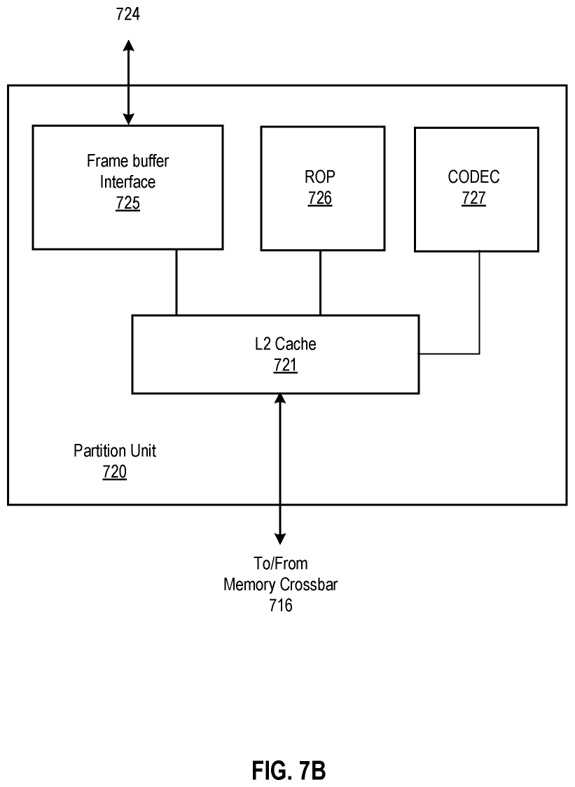

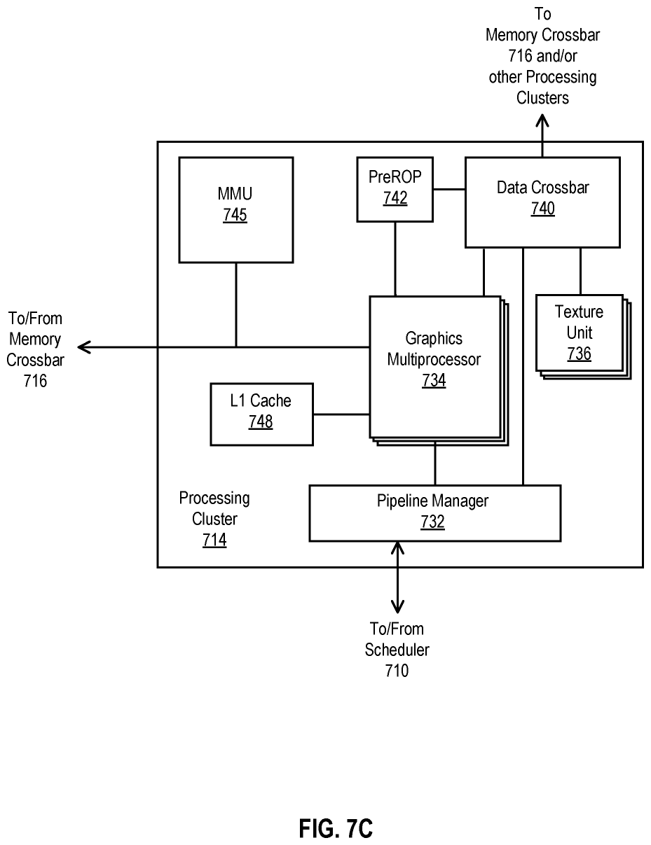

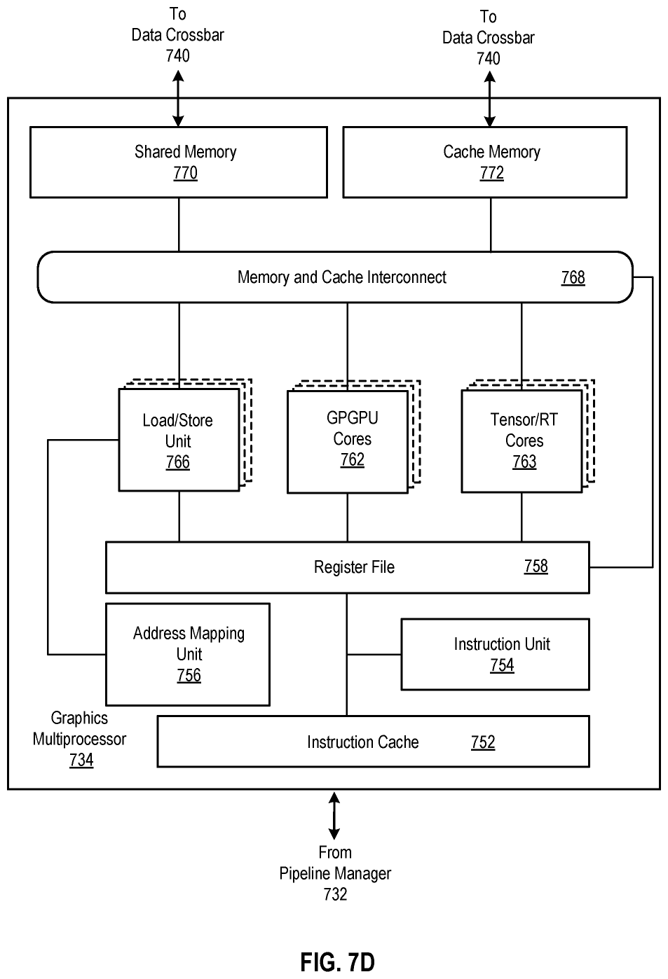

FIG. 7A illustrates examples of a parallel processor 700. The parallel processor 700 may be a GPU, GPGPU or the like as described herein. The various components of the parallel processor 700 may be implemented using one or more integrated circuit devices, such as programmable processors, application specific integrated circuits (ASICs), or field programmable gate arrays (FPGA). The parallel processor 700 may be one or more of the parallel processor(s) 612 shown in FIG. 6.

The parallel processor 700 includes a parallel processing unit 702. The parallel processing unit includes an I/O unit 704 that enables communication with other devices, including other instances of the parallel processing unit 702. The I/O unit 704 may be directly connected to other devices. For instance, the I/O unit 704 connects with other devices via the use of a hub or switch interface, such as memory hub 605. The connections between the memory hub 605 and the I/O unit 704 form a communication link 613. Within the parallel processing unit 702, the I/O unit 704 connects with a host interface 706 and a memory crossbar 716, where the host interface 706 receives commands directed to performing processing operations and the memory crossbar 716 receives commands directed to performing memory operations.

When the host interface 706 receives a command buffer via the I/O unit 704, the host interface 706 can direct work operations to perform those commands to a front end 708. In some examples the front end 708 couples with a scheduler 710, which is configured to distribute commands or other work items to a processing cluster array 712. The scheduler 710 ensures that the processing cluster array 712 is properly configured and in a valid state before tasks are distributed to the processing clusters of the processing cluster array 712. The scheduler 710 may be implemented via firmware logic executing on a microcontroller. The microcontroller implemented scheduler 710 is configurable to perform complex scheduling and work distribution operations at coarse and fine granularity, enabling rapid preemption and context switching of threads executing on the processing cluster array 712. Preferably, the host software can prove workloads for scheduling on the processing cluster array 712 via one of multiple graphics processing doorbells. In other examples, polling for new workloads or interrupts can be used to identify or indicate availability of work to perform. The workloads can then be automatically distributed across the processing cluster array 712 by the scheduler 710 logic within the scheduler microcontroller.

The processing cluster array 712 can include up to “N” processing clusters (e.g., cluster 714A, cluster 714B, through cluster 714N). Each cluster 714A-714N of the processing cluster array 712 can execute a large number of concurrent threads. The scheduler 710 can allocate work to the clusters 714A-714N of the processing cluster array 712 using various scheduling and/or work distribution algorithms, which may vary depending on the workload arising for each type of program or computation. The scheduling can be handled dynamically by the scheduler 710 or can be assisted in part by compiler logic during compilation of program logic configured for execution by the processing cluster array 712. Optionally, different clusters 714A-714N of the processing cluster array 712 can be allocated for processing different types of programs or for performing different types of computations.

The processing cluster array 712 can be configured to perform various types of parallel processing operations. For example, the processing cluster array 712 is configured to perform general-purpose parallel compute operations. For example, the processing cluster array 712 can include logic to execute processing tasks including filtering of video and/or audio data, performing modeling operations, including physics operations, and performing data transformations.

The processing cluster array 712 is configured to perform parallel graphics processing operations. In such examples in which the parallel processor 700 is configured to perform graphics processing operations, the processing cluster array 712 can include additional logic to support the execution of such graphics processing operations, including, but not limited to texture sampling logic to perform texture operations, as well as tessellation logic and other vertex processing logic. Additionally, the processing cluster array 712 can be configured to execute graphics processing related shader programs such as, but not limited to vertex shaders, tessellation shaders, geometry shaders, and pixel shaders. The parallel processing unit 702 can transfer data from system memory via the I/O unit 704 for processing. During processing the transferred data can be stored to on-chip memory (e.g., parallel processor memory 722) during processing, then written back to system memory.

In examples in which the parallel processing unit 702 is used to perform graphics processing, the scheduler 710 may be configured to divide the processing workload into approximately equal sized tasks, to better enable distribution of the graphics processing operations to multiple clusters 714A-714N of the processing cluster array 712. In some of these examples, portions of the processing cluster array 712 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 714A-714N may be stored in buffers to allow the intermediate data to be transmitted between clusters 714A-714N for further processing.

During operation, the processing cluster array 712 can receive processing tasks to be executed via the scheduler 710, which receives commands defining processing tasks from front end 708. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 710 may be configured to fetch the indices corresponding to the tasks or may receive the indices from the front end 708. The front end 708 can be configured to ensure the processing cluster array 712 is configured to a valid state before the workload specified by incoming command buffers (e.g., batch-buffers, push buffers, etc.) is initiated.

Each of the one or more instances of the parallel processing unit 702 can couple with parallel processor memory 722. The parallel processor memory 722 can be accessed via the memory crossbar 716, which can receive memory requests from the processing cluster array 712 as well as the I/O unit 704. The memory crossbar 716 can access the parallel processor memory 722 via a memory interface 718. The memory interface 718 can include multiple partition units (e.g., partition unit 720A, partition unit 720B, through partition unit 720N) that can each couple to a portion (e.g., memory unit) of parallel processor memory 722. The number of partition units 720A-720N may be configured to be equal to the number of memory units, such that a first partition unit 720A has a corresponding first memory unit 724A, a second partition unit 720B has a corresponding second memory unit 724B, and an Nth partition unit 720N has a corresponding Nth memory unit 724N. In other examples, the number of partition units 720A-720N may not be equal to the number of memory devices.

The memory units 724A-724N can include various types of memory devices, including dynamic random-access memory (DRAM) or graphics random access memory, such as synchronous graphics random access memory (SGRAM), including graphics double data rate (GDDR) memory. Optionally, the memory units 724A-724N may also include 3D stacked memory, including but not limited to high bandwidth memory (HBM). Persons skilled in the art will appreciate that the specific implementation of the memory units 724A-724N can vary and can be selected from one of various conventional designs. Render targets, such as frame buffers or texture maps may be stored across the memory units 724A-724N, allowing partition units 720A-720N to write portions of each render target in parallel to efficiently use the available bandwidth of parallel processor memory 722. In some examples, a local instance of the parallel processor memory 722 may be excluded in favor of a unified memory design that utilizes system memory in conjunction with local cache memory.

Optionally, any one of the clusters 714A-714N of the processing cluster array 712 has the ability to process data that will be written to any of the memory units 724A-724N within parallel processor memory 722. The memory crossbar 716 can be configured to transfer the output of each cluster 714A-714N to any partition unit 720A-720N or to another cluster 714A-714N, which can perform additional processing operations on the output. Each cluster 714A-714N can communicate with the memory interface 718 through the memory crossbar 716 to read from or write to various external memory devices. In one of the examples with the memory crossbar 716 the memory crossbar 716 has a connection to the memory interface 718 to communicate with the I/O unit 704, as well as a connection to a local instance of the parallel processor memory 722, enabling the processing units within the different processing clusters 714A-714N to communicate with system memory or other memory that is not local to the parallel processing unit 702. Generally, the memory crossbar 716 may, for example, be able to use virtual channels to separate traffic streams between the clusters 714A-714N and the partition units 720A-720N.

While a single instance of the parallel processing unit 702 is illustrated within the parallel processor 700, any number of instances of the parallel processing unit 702 can be included. For example, multiple instances of the parallel processing unit 702 can be provided on a single add-in card, or multiple add-in cards can be interconnected. For example, the parallel processor 700 can be an add-in device, such as add-in device(s) 620 of FIG. 6, which may be a graphics card such as a discrete graphics card that includes one or more GPUs, one or more memory devices, and device-to-device or network or fabric interfaces. The different instances of the parallel processing unit 702 can be configured to inter-operate even if the different instances have different numbers of processing cores, different amounts of local parallel processor memory, and/or other configuration differences. Optionally, some instances of the parallel processing unit 702 can include higher precision floating point units relative to other instances. Systems incorporating one or more instances of the parallel processing unit 702 or the parallel processor 700 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 702 can be partitioned into multiple instances. Those multiple instances can be configured to execute workloads associated with different clients in an isolated manner, enabling a pre-determined quality of service to be provided for each client. For example, each cluster 714A-714N can be compartmentalized and isolated from other clusters, allowing the processing cluster array 712 to be divided into multiple compute partitions or instances. In such configuration, workloads that execute on an isolated partition are protected from faults or errors associated with a different workload that executes on a different partition. The partition units 720A-720N can be configured to enable a dedicated and/or isolated path to memory for the clusters 714A-714N associated with the respective compute partitions. This datapath isolation enables the compute resources within a partition can communicate with one or more assigned memory units 724A-724N without being subjected to inference by the activities of other partitions.

FIG. 7B is a block diagram of a partition unit 720. The partition unit 720 may be an instance of one of the partition units 720A-720N of FIG. 7A. As illustrated, the partition unit 720 includes an L2 cache 721, a frame buffer interface 725, and a ROP 726 (raster operations unit). The L2 cache 721 is a read/write cache that is configured to perform load and store operations received from the memory crossbar 716 and ROP 726. Read misses and urgent write-back requests are output by L2 cache 721 to frame buffer interface 725 for processing. Updates can also be sent to the frame buffer via the frame buffer interface 725 for processing. In some examples the frame buffer interface 725 interfaces with one of the memory units in parallel processor memory, such as the memory units 724A-724N of FIG. 7A (e.g., within parallel processor memory 722). The partition unit 720 may additionally or alternatively also interface with one of the memory units in parallel processor memory via a memory controller (not shown).

In graphics applications, the ROP 726 is a processing unit that performs raster operations such as stencil, z test, blending, and the like. The ROP 726 then outputs processed graphics data that is stored in graphics memory. In some examples the ROP 726 includes or couples with a CODEC 727 that includes compression logic to compress depth or color data that is written to memory or the L2 cache 721 and decompress depth or color data that is read from memory or the L2 cache 721. The compression logic can be lossless compression logic that makes use of one or more of multiple compression algorithms. The type of compression that is performed by the CODEC 727 can vary based on the statistical characteristics of the data to be compressed. For example, in some examples, delta color compression is performed on depth and color data on a per-tile basis. In some examples the CODEC 727 includes compression and decompression logic that can compress and decompress compute data associated with machine learning operations. The CODEC 727 can, for example, compress sparse matrix data for sparse machine learning operations. The CODEC 727 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 726 may be included within each processing cluster (e.g., cluster 714A-714N of FIG. 7A) instead of within the partition unit 720. In such example, read and write requests for pixel data are transmitted over the memory crossbar 716 instead of pixel fragment data. The processed graphics data may be displayed on a display device, such as one of the one or more display device(s) 610A-610B of FIG. 6, routed for further processing by the processor(s) 602, or routed for further processing by one of the processing entities within the parallel processor 700 of FIG. 7A.

FIG. 7C is a block diagram of a processing cluster 714 within a parallel processing unit. For example, the processing cluster is an instance of one of the processing clusters 714A-714N of FIG. 7A. The processing cluster 714 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 714 can be controlled via a pipeline manager 732 that distributes processing tasks to SIMT parallel processors. The pipeline manager 732 receives instructions from the scheduler 710 of FIG. 7A and manages execution of those instructions via a graphics multiprocessor 734 and/or a texture unit 736. The graphics multiprocessor 734 is an exemplary instance of a SIMT parallel processor. However, various types of SIMT parallel processors of differing architectures may be included within the processing cluster 714. One or more instances of the graphics multiprocessor 734 can be included within a processing cluster 714. The graphics multiprocessor 734 can process data and a data crossbar 740 can be used to distribute the processed data to one of multiple possible destinations, including other shader units. The pipeline manager 732 can facilitate the distribution of processed data by specifying destinations for processed data to be distributed via the data crossbar 740.

Each graphics multiprocessor 734 within the processing cluster 714 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 714 constitute a thread. A set of threads executing across the set of parallel processing engines is a thread group. A thread group executes the same program on different input data. Each thread within a thread group can be assigned to a different processing engine within a graphics multiprocessor 734. A thread group may include fewer threads than the number of processing engines within the graphics multiprocessor 734. When a thread group includes fewer threads than the number of processing engines, one or more of the processing engines may be idle during cycles in which that thread group is being processed. A thread group may also include more threads than the number of processing engines within the graphics multiprocessor 734. When the thread group includes more threads than the number of processing engines within the graphics multiprocessor 734, processing can be performed over consecutive clock cycles. Optionally, multiple thread groups can be executed concurrently on the graphics multiprocessor 734.

The graphics multiprocessor 734 may include an internal cache memory to perform load and store operations. Optionally, the graphics multiprocessor 734 can forego an internal cache and use a cache memory (e.g., level 1 (L1) cache 748) within the processing cluster 714. Each graphics multiprocessor 734 also has access to level 2 (L2) caches within the partition units (e.g., partition units 720A-720N of FIG. 7A) that are shared among all processing clusters 714 and may be used to transfer data between threads. The graphics multiprocessor 734 may also access off-chip global memory, which can include one or more of local parallel processor memory and/or system memory. Any memory external to the parallel processing unit 702 may be used as global memory. Embodiments in which the processing cluster 714 includes multiple instances of the graphics multiprocessor 734 can share common instructions and data, which may be stored in the L1 cache 748.

Each processing cluster 714 may include an MMU 745 (memory management unit) that is configured to map virtual addresses into physical addresses. In other examples, one or more instances of the MMU 745 may reside within the memory interface 718 of FIG. 7A. The MMU 745 includes a set of page table entries (PTEs) used to map a virtual address to a physical address of a tile and optionally a cache line index. The MMU 745 may include address translation lookaside buffers (TLB) or caches that may reside within the graphics multiprocessor 734 or the L1 cache 748 of processing cluster 714. The physical address is processed to distribute surface data access locality to allow efficient request interleaving among partition units. The cache line index may be used to determine whether a request for a cache line is a hit or miss.

In graphics and computing applications, a processing cluster 714 may be configured such that each graphics multiprocessor 734 is coupled to a texture unit 736 for performing texture mapping operations, e.g., determining texture sample positions, reading texture data, and filtering the texture data. Texture data is read from an internal texture L1 cache (not shown) or in some examples from the L1 cache within graphics multiprocessor 734 and is fetched from an L2 cache, local parallel processor memory, or system memory, as needed. Each graphics multiprocessor 734 outputs processed tasks to the data crossbar 740 to provide the processed task to another processing cluster 714 for further processing or to store the processed task in an L2 cache, local parallel processor memory, or system memory via the memory crossbar 716. A preROP 742 (pre-raster operations unit) is configured to receive data from graphics multiprocessor 734, direct data to ROP units, which may be located with partition units as described herein (e.g., partition units 720A-720N of FIG. 7A). The preROP 742 unit can perform optimizations for color blending, organize pixel color data, and perform address translations.

It will be appreciated that the core architecture described herein is illustrative and that variations and modifications are possible. Any number of processing units, e.g., graphics multiprocessor 734, texture units 736, preROPs 742, etc., may be included within a processing cluster 714. Further, while only one processing cluster 714 is shown, a parallel processing unit as described herein may include any number of instances of the processing cluster 714. Optionally, each processing cluster 714 can be configured to operate independently of other processing clusters 714 using separate and distinct processing units, L1 caches, L2 caches, etc.

FIG. 7D shows an example of the graphics multiprocessor 734 in which the graphics multiprocessor 734 couples with the pipeline manager 732 of the processing cluster 714. The graphics multiprocessor 734 has an execution pipeline including but not limited to an instruction cache 752, an instruction unit 754, an address mapping unit 756, a register file 758, one or more general purpose graphics processing unit (GPGPU) cores 762, and one or more load/store units 766. The GPGPU cores 762 and load/store units 766 are coupled with cache memory 772 and shared memory 770 via a memory and cache interconnect 768. The graphics multiprocessor 734 may additionally include tensor and/or ray-tracing cores 763 that include hardware logic to accelerate matrix and/or ray-tracing operations.

The instruction cache 752 may receive a stream of instructions to execute from the pipeline manager 732. The instructions are cached in the instruction cache 752 and dispatched for execution by the instruction unit 754. The instruction unit 754 can dispatch instructions as thread groups (e.g., warps), with each thread of the thread group assigned to a different execution unit within GPGPU core 762. An instruction can access any of a local, shared, or global address space by specifying an address within a unified address space. The address mapping unit 756 can be used to translate addresses in the unified address space into a distinct memory address that can be accessed by the load/store units 766.

The register file 758 provides a set of registers for the functional units of the graphics multiprocessor 734. The register file 758 provides temporary storage for operands connected to the data paths of the functional units (e.g., GPGPU cores 762, load/store units 766) of the graphics multiprocessor 734. The register file 758 may be divided between each of the functional units such that each functional unit is allocated a dedicated portion of the register file 758. For example, the register file 758 may be divided between the different warps being executed by the graphics multiprocessor 734.

The GPGPU cores 762 can each include floating point units (FPUs) and/or integer arithmetic logic units (ALUs) that are used to execute instructions of the graphics multiprocessor 734. In some implementations, the GPGPU cores 762 can include hardware logic that may otherwise reside within the tensor and/or ray-tracing cores 763. The GPGPU cores 762 can be similar in architecture or can differ in architecture. For example and in some examples, a first portion of the GPGPU cores 762 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 734 can additionally include one or more fixed function or special function units to perform specific functions such as copy rectangle or pixel blending operations. One or more of the GPGPU cores can also include fixed or special function logic.

The GPGPU cores 762 may include SIMD logic capable of performing a single instruction on multiple sets of data. Optionally, GPGPU cores 762 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 768 is an interconnect network that connects each of the functional units of the graphics multiprocessor 734 to the register file 758 and to the shared memory 770. For example, the memory and cache interconnect 768 is a crossbar interconnect that allows the load/store unit 766 to implement load and store operations between the shared memory 770 and the register file 758. The register file 758 can operate at the same frequency as the GPGPU cores 762, thus data transfer between the GPGPU cores 762 and the register file 758 is very low latency. The shared memory 770 can be used to enable communication between threads that execute on the functional units within the graphics multiprocessor 734. The cache memory 772 can be used as a data cache for example, to cache texture data communicated between the functional units and the texture unit 736. The shared memory 770 can also be used as a program managed cached. The shared memory 770 and the cache memory 772 can couple with the data crossbar 740 to enable communication with other components of the processing cluster. Threads executing on the GPGPU cores 762 can programmatically store data within the shared memory in addition to the automatically cached data that is stored within the cache memory 772.

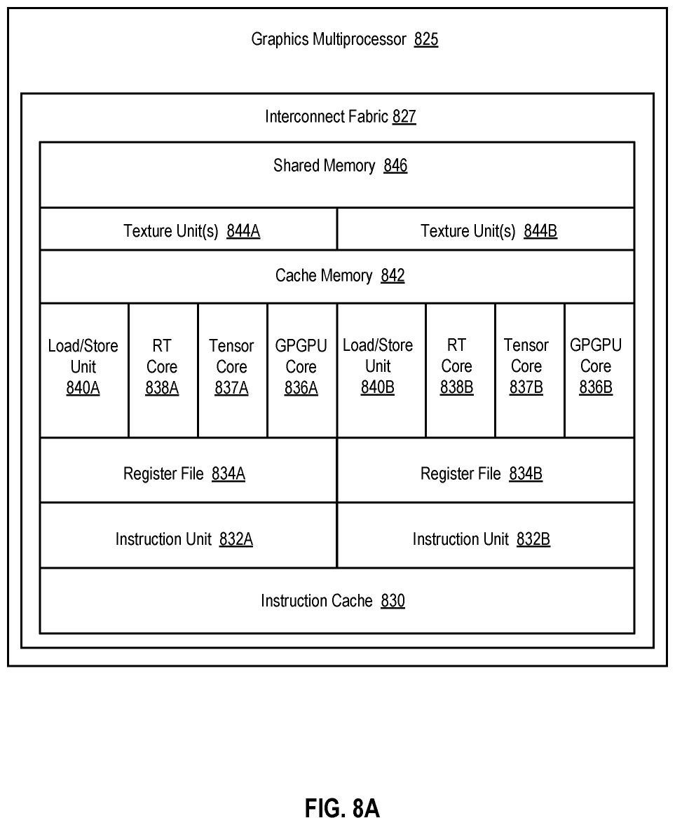

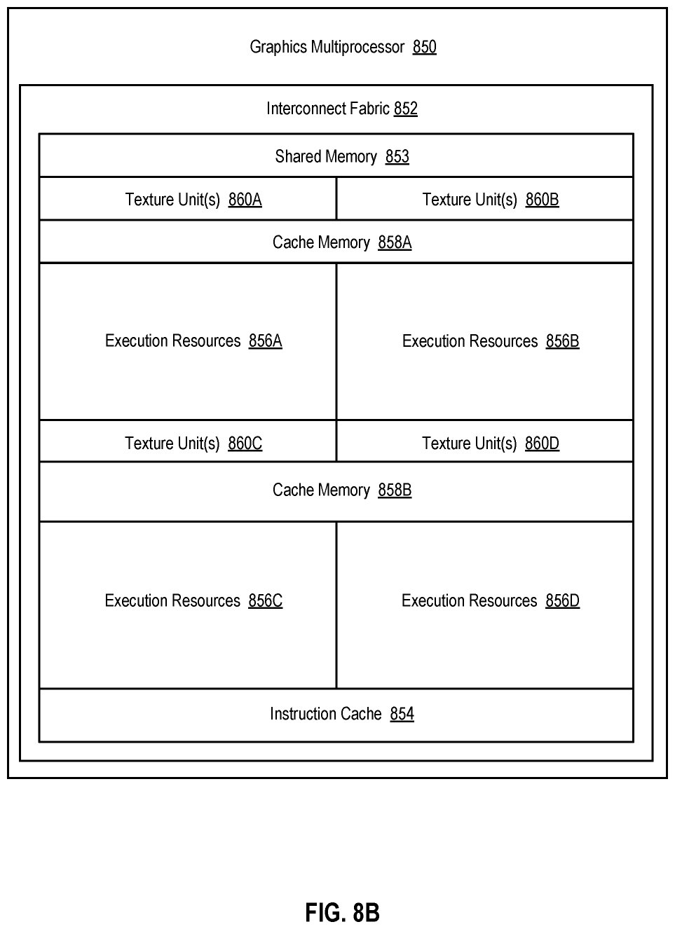

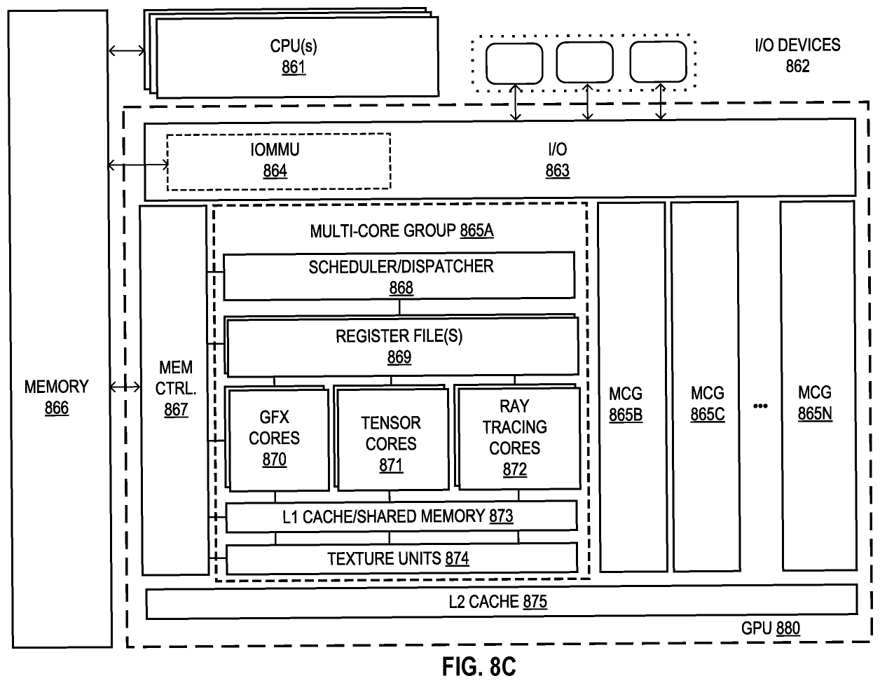

FIGS. 8A-8C illustrate additional graphics multiprocessors, according to examples. FIG. 8A-8B illustrate graphics multiprocessors 825, 850, which are related to the graphics multiprocessor 734 of FIG. 7C and may be used in place of one of those. Therefore, the disclosure of any features in combination with the graphics multiprocessor 734 herein also discloses a corresponding combination with the graphics multiprocessors 825, 850, but is not limited to such. FIG. 8C illustrates a graphics processing unit (GPU) 880 which includes dedicated sets of graphics processing resources arranged into multi-core groups 865A-865N, which correspond to the graphics multiprocessors 825, 850. The illustrated graphics multiprocessors 825, 850 and the multi-core groups 865A-865N can be streaming multiprocessors (SM) capable of simultaneous execution of a large number of execution threads.

The graphics multiprocessor 825 of FIG. 8A includes multiple additional instances of execution resource units relative to the graphics multiprocessor 734 of FIG. 7D. For example, the graphics multiprocessor 825 can include multiple instances of the instruction unit 832A-832B, register file 834A-834B, and texture unit(s) 844A-844B. The graphics multiprocessor 825 also includes multiple sets of graphics or compute execution units (e.g., GPGPU core 836A-836B, tensor core 837A-837B, ray-tracing core 838A-838B) and multiple sets of load/store units 840A-840B. The execution resource units have a common instruction cache 830, texture and/or data cache memory 842, and shared memory 846.

The various components can communicate via an interconnect fabric 827. The interconnect fabric 827 may include one or more crossbar switches to enable communication between the various components of the graphics multiprocessor 825. The interconnect fabric 827 may be a separate, high-speed network fabric layer upon which each component of the graphics multiprocessor 825 is stacked. The components of the graphics multiprocessor 825 communicate with remote components via the interconnect fabric 827. For example, the cores 836A-836B, 837A-837B, and 838A-838B can each communicate with shared memory 846 via the interconnect fabric 827. The interconnect fabric 827 can arbitrate communication within the graphics multiprocessor 825 to ensure a fair bandwidth allocation between components.

The graphics multiprocessor 850 of FIG. 8B includes multiple sets of execution resources 856A-856D, where each set of execution resource includes multiple instruction units, register files, GPGPU cores, and load store units, as illustrated in FIG. 7D and FIG. 8A. The execution resources 856A-856D can work in concert with texture unit(s) 860A-860D for texture operations, while sharing an instruction cache 854, and shared memory 853. For example, the execution resources 856A-856D can share an instruction cache 854 and shared memory 853, as well as multiple instances of a texture and/or data cache memory 858A-858B. The various components can communicate via an interconnect fabric 852 similar to the interconnect fabric 827 of FIG. 8A.

Persons skilled in the art will understand that the architecture described in FIGS. 1, 7A-7D, and 8A-8B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 702 of FIG. 7A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 8C illustrates a graphics processing unit (GPU) 880 which includes dedicated sets of graphics processing resources arranged into multi-core groups 865A-865N. While the details of only a single multi-core group 865A are provided, it will be appreciated that the other multi-core groups 865B-865N may be equipped with the same or similar sets of graphics processing resources. Details described with respect to the multi-core groups 865A-865N may also apply to any graphics multiprocessor 734, 825, 850 described herein.

As illustrated, a multi-core group 865A may include a set of graphics cores 870, a set of tensor cores 871, and a set of ray tracing cores 872. A scheduler/dispatcher 868 schedules and dispatches the graphics threads for execution on the various cores 870, 871, 872. A set of register files 869 store operand values used by the cores 870, 871, 872 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 873 store graphics data such as texture data, vertex data, pixel data, ray data, bounding volume data, etc., locally within each multi-core group 865A. One or more texture units 874 can also be used to perform texturing operations, such as texture mapping and sampling. A Level 2 (L2) cache 875 shared by all or a subset of the multi-core groups 865A-865N stores graphics data and/or instructions for multiple concurrent graphics threads. As illustrated, the L2 cache 875 may be shared across a plurality of multi-core groups 865A-865N. One or more memory controllers 867 couple the GPU 880 to a memory 866 which may be a system memory (e.g., DRAM) and/or a dedicated graphics memory (e.g., GDDR6 memory).

Input/output (I/O) circuitry 863 couples the GPU 880 to one or more I/O devices 862 such as digital signal processors (DSPs), network controllers, or user input devices. An on-chip interconnect may be used to couple the I/O devices 862 to the GPU 880 and memory 866. One or more I/O memory management units (IOMMUs) 864 of the I/O circuitry 863 couple the I/O devices 862 directly to the system memory 866. Optionally, the IOMMU 864 manages multiple sets of page tables to map virtual addresses to physical addresses in system memory 866. The I/O devices 862, CPU(s) 861, and GPU(s) 880 may then share the same virtual address space.

In one implementation of the IOMMU 864, the IOMMU 864 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 866). The base addresses of each of the first and second sets of page tables may be stored in control registers and swapped out on a context switch (e.g., so that the new context is provided with access to the relevant set of page tables). While not illustrated in FIG. 8C, each of the cores 870, 871, 872 and/or multi-core groups 865A-865N may include translation lookaside buffers (TLBs) to cache guest virtual to guest physical translations, guest physical to host physical translations, and guest virtual to host physical translations.

The CPU(s) 861, GPUs 880, and I/O devices 862 may be integrated on a single semiconductor chip and/or chip package. The illustrated memory 866 may be integrated on the same chip or may be coupled to the memory controllers 867 via an off-chip interface. In one implementation, the memory 866 comprises GDDR6 memory which shares the same virtual address space as other physical system-level memories, although the underlying principles described herein are not limited to this specific implementation.

The tensor cores 871 may include a plurality of execution units specifically designed to perform matrix operations, which are the fundamental compute operation used to perform deep learning operations. For example, simultaneous matrix multiplication operations may be used for neural network training and inferencing. The tensor cores 871 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 871. The training of neural networks, in particular, requires a significant number of matrix dot product operations. In order to process an inner-product formulation of an N×N×N matrix multiply, the tensor cores 871 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 871 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 871 support a sparse mode of operation for matrices in which the vast majority of values are zero. The tensor cores 871 include support for sparse input matrices that are encoded in a sparse matrix representation (e.g., coordinate list encoding (COO), compressed sparse row (CSR), compress sparse column (CSC), etc.). The tensor cores 871 also include support for compressed sparse matrix representations in the event that the sparse matrix representation may be further compressed. Compressed, encoded, and/or compressed and encoded matrix data, along with associated compression and/or encoding metadata, can be read by the tensor cores 871 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 871, output matrix C may be output in a compressed format, a sparse encoding, or a compressed sparse encoding.

The ray tracing cores 872 may accelerate ray tracing operations for both real-time ray tracing and non-real-time ray tracing implementations. In particular, the ray tracing cores 872 may include ray traversal/intersection circuitry for performing ray traversal using bounding volume hierarchies (BVHs) and identifying intersections between rays and primitives enclosed within the BVH volumes. The ray tracing cores 872 may also include circuitry for performing depth testing and culling (e.g., using a Z buffer or similar arrangement). In one implementation, the ray tracing cores 872 perform traversal and intersection operations in concert with the image denoising techniques described herein, at least a portion of which may be executed on the tensor cores 871. For example, the tensor cores 871 may implement a deep learning neural network to perform denoising of frames generated by the ray tracing cores 872. However, the CPU(s) 861, graphics cores 870, and/or ray tracing cores 872 may also implement all or a portion of the denoising and/or deep learning algorithms.

In addition, as described above, a distributed approach to denoising may be employed in which the GPU 880 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 872 may process all BVH traversal and/or ray-primitive intersections, saving the graphics cores 870 from being overloaded with thousands of instructions per ray. For example, each ray tracing core 872 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 865A can simply launch a ray probe, and the ray tracing cores 872 independently perform ray traversal and intersection and return hit data (e.g., a hit, no hit, multiple hits, etc.) to the thread context. The other cores 870, 871 are freed to perform other graphics or compute work while the ray tracing cores 872 perform the traversal and intersection operations.

Optionally, each ray tracing core 872 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 870 and tensor cores 871) are freed to perform other forms of graphics work.

In some examples described below, a hybrid rasterization/ray tracing approach is used in which work is distributed between the graphics cores 870 and ray tracing cores 872.

The ray tracing cores 872 (and/or other cores 870, 871) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 872, graphics cores 870 and tensor cores 871 is Vulkan API (e.g., Vulkan version 1.1.85 and later). Note, however, that the underlying principles described herein are not limited to any particular ray tracing ISA.

In general, the various cores 872, 871, 870 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation-Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 872 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 872 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 872 can also be used to perform computations that are not directly analogous to ray tracing. For example, mesh projection, mesh refinement, and volume sampling computations can be accelerated using the ray tracing cores 872. Generic coordinate space calculations, such as nearest neighbor calculations can also be performed. For example, the set of points near a given point can be discovered by defining a bounding box in the coordinate space around the point. BVH and ray probe logic within the ray tracing cores 872 can then be used to determine the set of point intersections within the bounding box. The intersections constitute the origin point and the nearest neighbors to that origin point. Computations that are performed using the ray tracing cores 872 can be performed in parallel with computations performed on the graphics cores 872 and tensor cores 871. A shader compiler can be configured to compile a compute shader or other general-purpose graphics processing program into low level primitives that can be parallelized across the graphics cores 870, tensor cores 871, and ray tracing cores 872.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

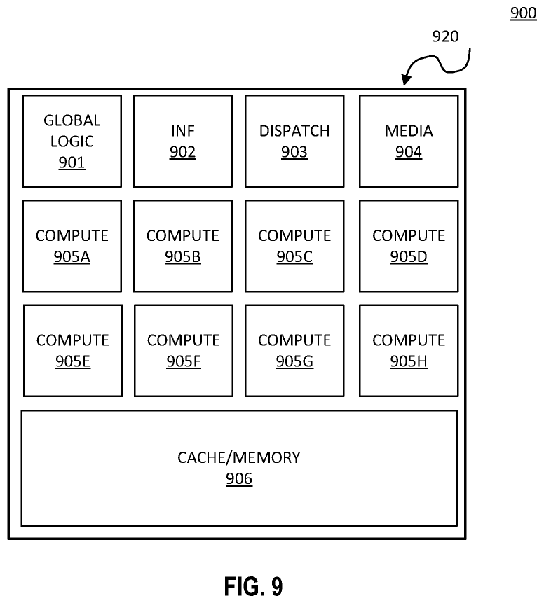

FIG. 9 shows a parallel compute system 900, according to some examples. In some examples the parallel compute system 900 includes a parallel processor 920, which can be a graphics processor or compute accelerator as described herein. The parallel processor 920 includes a global logic unit 901, an interface 902, a thread dispatcher 903, a media unit 904, a set of compute units 905A-905H, and a cache/memory units 906. The global logic unit 901, in some examples, includes global functionality for the parallel processor 920, including device configuration registers, global schedulers, power management logic, and the like. The interface 902 can include a front-end interface for the parallel processor 920. The thread dispatcher 903 can receive workloads from the interface 902 and dispatch threads for the workload to the compute units 905A-905H. If the workload includes any media operations, at least a portion of those operations can be performed by the media unit 904. The media unit can also offload some operations to the compute units 905A-905H. The cache/memory units 906 can include cache memory (e.g., L3 cache) and local memory (e.g., HBM, GDDR) for the parallel processor 920. Compute units 905 may include units for one or more of a network or communication processor, a core, a graphics processor, a general purpose graphics processing unit (GPGPU), a neural-network processing unit (NPU), an embedded processor, a security processor, a cryptographic accelerator, a matrix accelerator, an in-memory analytics accelerator, a compression accelerator, a data streaming accelerator, or the like.

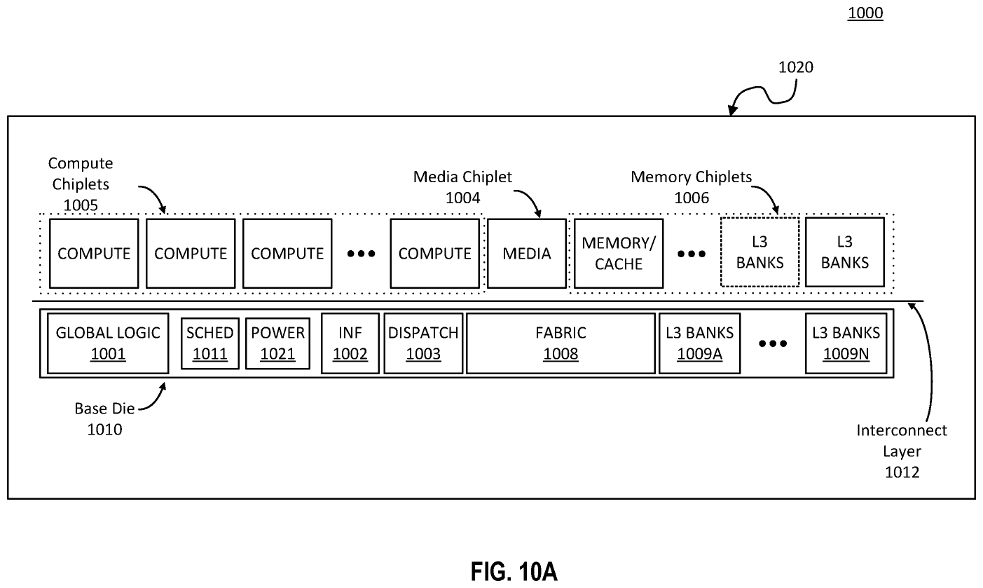

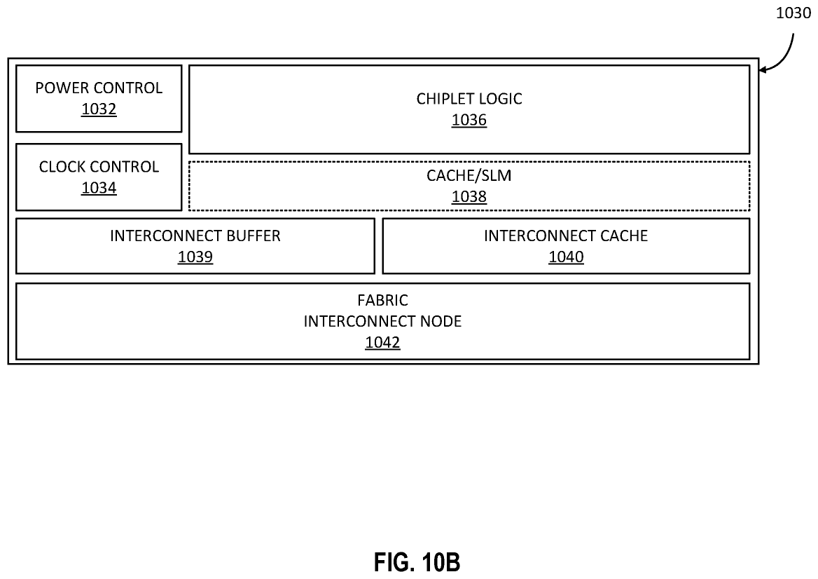

FIGS. 10A-10B illustrate a hybrid logical/physical view of a disaggregated parallel processor, according to examples described herein. FIG. 10A illustrates a disaggregated parallel compute system 1000. FIG. 10B illustrates a chiplet 1030 of the disaggregated parallel compute system 1000.

As shown in FIG. 10A, a disaggregated parallel compute system 1000 can include a parallel processor 1020 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 1005, a media chiplet 1004, and memory chiplets 1006. Each chiplet can be separately manufactured using different process technologies. For example, compute chiplets 1005 may be manufactured using the smallest or most advanced process technology available at the time of fabrication, while memory chiplets 1006 or other chiplets (e.g., I/O, networking, etc.) may be manufactured using a larger or less advanced process technologies.

The various chiplets can be bonded to a base die 1010 and configured to communicate with each other and logic within the base die 1010 via an interconnect layer 1012. In some examples, the base die 1010 can include global logic 1001, which can include scheduler 1011 and power management 1021 logic units, an interface 1002, a dispatch unit 1003, and an interconnect fabric 1008 coupled with or integrated with one or more L3 cache banks 1009A-1009N. The interconnect fabric 1008 can be an inter-chiplet fabric that is integrated into the base die 1010. Logic chiplets can use the fabric 1008 to relay messages between the various chiplets. Additionally, L3 cache banks 1009A-1009N in the base die and/or L3 cache banks within the memory chiplets 1006 can cache data read from and transmitted to DRAM chiplets within the memory chiplets 1006 and to system memory of a host.

In some examples the global logic 1001 is a microcontroller that can execute firmware to perform scheduler 1011 and power management 1021 functionality for the parallel processor 1020. The microcontroller that executes the global logic can be tailored for the target use case of the parallel processor 1020. The scheduler 1011 can perform global scheduling operations for the parallel processor 1020. The power management 1021 functionality can be used to enable or disable individual chiplets within the parallel processor when those chiplets are not in use.

The various chiplets of the parallel processor 1020 can be designed to perform specific functionality that, in existing designs, would be integrated into a single die. A set of compute chiplets 1005 can include clusters of compute units (e.g., execution units, streaming multiprocessors, etc.) that include programmable logic to execute compute or graphics shader instructions. A media chiplet 1004 can include hardware logic to accelerate media encode and decode operations. Memory chiplets 1006 can include volatile memory (e.g., DRAM) and one or more SRAM cache memory banks (e.g., L3 banks).

As shown in FIG. 10B, each chiplet 1030 can include common components and application specific components. Chiplet logic 1036 within the chiplet 1030 can include the specific components of the chiplet, such as an array of streaming multiprocessors, compute units, or execution units described herein. The chiplet logic 1036 can couple with an optional cache or shared local memory 1038 or can include a cache or shared local memory within the chiplet logic 1036. The chiplet 1030 can include a fabric interconnect node 1042 that receives commands via the inter-chiplet fabric. Commands and data received via the fabric interconnect node 1042 can be stored temporarily within an interconnect buffer 1039. Data transmitted to and received from the fabric interconnect node 1042 can be stored in an interconnect cache 1040. Power control 1032 and clock control 1034 logic can also be included within the chiplet. The power control 1032 and clock control 1034 logic can receive configuration commands via the fabric can configure dynamic voltage and frequency scaling for the chiplet 1030. In some examples, each chiplet can have an independent clock domain and power domain and can be clock gated and power gated independently of other chiplets.

At least a portion of the components within the illustrated chiplet 1030 can also be included within logic embedded within the base die 1010 of FIG. 10A. For example, logic within the base die that communicates with the fabric can include a version of the fabric interconnect node 1042. Base die logic that can be independently clock or power gated can include a version of the power control 1032 and/or clock control 1034 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

### Example Core Architectures—In-Order and Out-of-Order Core Block Diagram.

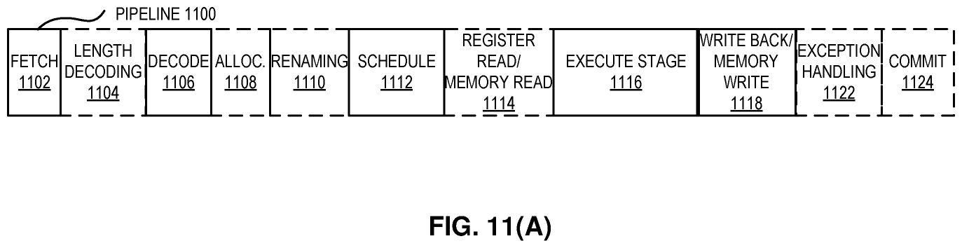

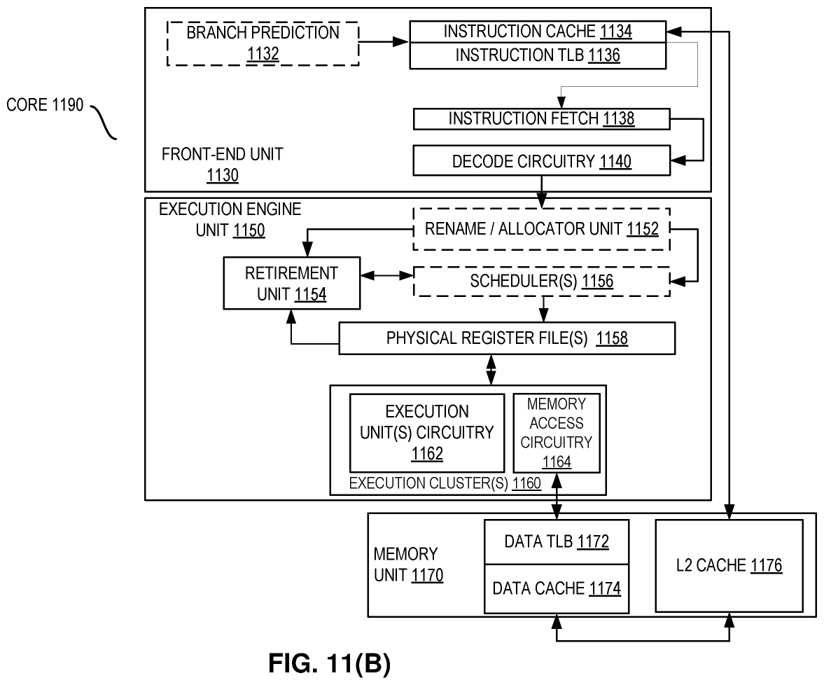

FIG. 11(A) is a block diagram illustrating both an example in-order pipeline and an example register renaming, out-of-order issue/execution pipeline according to examples. FIG. 11(B) is a block diagram illustrating both an example in-order architecture core and an example register renaming, out-of-order issue/execution architecture core to be included in a processor according to examples. The solid lined boxes in FIGS. 11(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11(A), a processor pipeline 1100 includes a fetch stage 1102, an optional length decoding stage 1104, a decode stage 1106, an optional allocation (Alloc) stage 1108, an optional renaming stage 1110, a schedule (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, and during the decode stage 1106, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1106 and the register read/memory read stage 1114 may be combined into one pipeline stage. In some examples, during the execute stage 1116, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 11(B) may implement the pipeline 1100 as follows: 1) the instruction fetch circuitry 1138 performs the fetch and length decoding stages 1102 and 1104; 2) the decode circuitry 1140 performs the decode stage 1106; 3) the rename/allocator unit circuitry 1152 performs the allocation stage 1108 and renaming stage 1110; 4) the scheduler(s) circuitry 1156 performs the schedule stage 1112; 5) the physical register file(s) circuitry 1158 and the memory unit circuitry 1170 perform the register read/memory read stage 1114; the execution cluster(s) 1160 perform the execute stage 1116; 6) the memory unit circuitry 1170 and the physical register file(s) circuitry 1158 perform the write back/memory write stage 1118; 7) various circuitry may be involved in the exception handling stage 1122; and 8) the retirement unit circuitry 1154 and the physical register file(s) circuitry 1158 perform the commit stage 1124.

FIG. 11(B) shows a processor core 1190 including front-end unit circuitry 1130 coupled to execution engine unit circuitry 1150, and both are coupled to memory unit circuitry 1170. The core 1190 may be a reduced instruction set architecture computing (RISC) core, a complex instruction set architecture computing (CISC) core, a very long instruction word (VLIW) core, or a hybrid or alternative core type. As yet another option, the core 1190 may be a special-purpose core, such as, for example, a network or communication core, compression engine, co-processor core, general purpose computing graphics processing unit (GPGPU) core, graphics core, or the like.

The front-end unit circuitry 1130 may include branch prediction circuitry 1132 coupled to instruction cache circuitry 1134, which is coupled to an instruction translation lookaside buffer (TLB) 1136, which is coupled to instruction fetch circuitry 1138, which is coupled to decode circuitry 1140. In some examples, the instruction cache circuitry 1134 is included in the memory unit circuitry 1170 rather than the front-end unit circuitry 1130. The decode circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1140 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1140 may be implemented using various different mechanisms. Examples of suitable mechanisms include, but are not limited to, look-up tables, hardware implementations, programmable logic arrays (PLAs), microcode read only memories (ROMs), etc. In some examples, the core 1190 includes a microcode ROM (not shown) or other medium that stores microcode for certain macroinstructions (e.g., in decode circuitry 1140 or otherwise within the front-end unit circuitry 1130). In some examples, the decode circuitry 1140 includes a micro-operation (micro-op) or operation cache (not shown) to hold/cache decoded operations, micro-tags, or micro-operations generated during the decode or other stages of the processor pipeline 1100. The decode circuitry 1140 may be coupled to rename/allocator unit circuitry 1152 in the execution engine unit circuitry 1150.

The execution engine unit circuitry 1150 includes the rename/allocator unit circuitry 1152 coupled to retirement unit circuitry 1154 and a set of one or more scheduler(s) circuitry 1156. The scheduler(s) circuitry 1156 represents any number of different schedulers, including reservations stations, central instruction window, etc. In some examples, the scheduler(s) circuitry 1156 can include arithmetic logic unit (ALU) scheduler/scheduling circuitry, ALU queues, address generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1158 includes vector registers unit circuitry, writemask registers unit circuitry, and scalar register unit circuitry. These register units may provide architectural vector registers, vector mask registers, general-purpose registers, etc. The physical register file(s) circuitry 1158 is coupled to the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution unit(s) circuitry 1162 and a set of one or more memory access circuitry 1164. The execution unit(s) circuitry 1162 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 1162 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1156, physical register file(s) circuitry 1158, and execution cluster(s) 1160 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1164). It should also be understood that where separate pipelines are used, one or more of these pipelines may be out-of-order issue/execution and the rest in-order.

In some examples, the execution engine unit circuitry 1150 may perform load store unit (LSU) address/data pipelining to an Advanced Microcontroller Bus (AMB) interface (not shown), and address phase and writeback, data phase load, store, and branches.

The set of memory access circuitry 1164 is coupled to the memory unit circuitry 1170, which includes data TLB circuitry 1172 coupled to data cache circuitry 1174 coupled to level 2 (L2) cache circuitry 1176. In some examples, the memory access circuitry 1164 may include load unit circuitry, store address unit circuitry, and store data unit circuitry, each of which is coupled to the data TLB circuitry 1172 in the memory unit circuitry 1170. The instruction cache circuitry 1134 is further coupled to the level 2 (L2) cache circuitry 1176 in the memory unit circuitry 1170. In some examples, the instruction cache 1134 and the data cache 1174 are combined into a single instruction and data cache (not shown) in L2 cache circuitry 1176, level 3 (L3) cache circuitry (not shown), and/or main memory. The L2 cache circuitry 1176 is coupled to one or more other levels of cache and eventually to a main memory.

The core 1190 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 1190 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry.

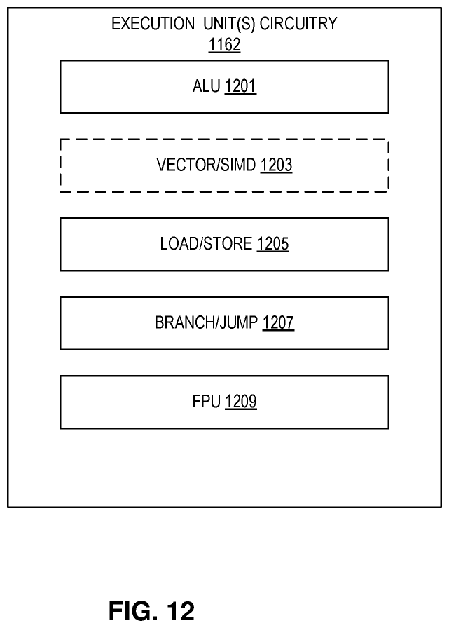

FIG. 12 illustrates examples of execution unit(s) circuitry, such as execution unit(s) circuitry 1162 of FIG. 11(B). As illustrated, execution unit(s) circuitry 1162 may include one or more ALU circuits 1201, optional vector/single instruction multiple data (SIMD) circuits 1203, load/store circuits 1205, branch/jump circuits 1207, and/or Floating-point unit (FPU) circuits 1209. ALU circuits 1201 perform integer arithmetic and/or Boolean operations. Vector/SIMD circuits 1203 perform vector/SIMD operations on packed data (such as SIMD/vector registers). Load/store circuits 1205 execute load and store instructions to load data from memory into registers or store from registers to memory. Load/store circuits 1205 may also generate addresses. Branch/jump circuits 1207 cause a branch or jump to a memory address depending on the instruction. FPU circuits 1209 perform floating-point arithmetic. The width of the execution unit(s) circuitry 1162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

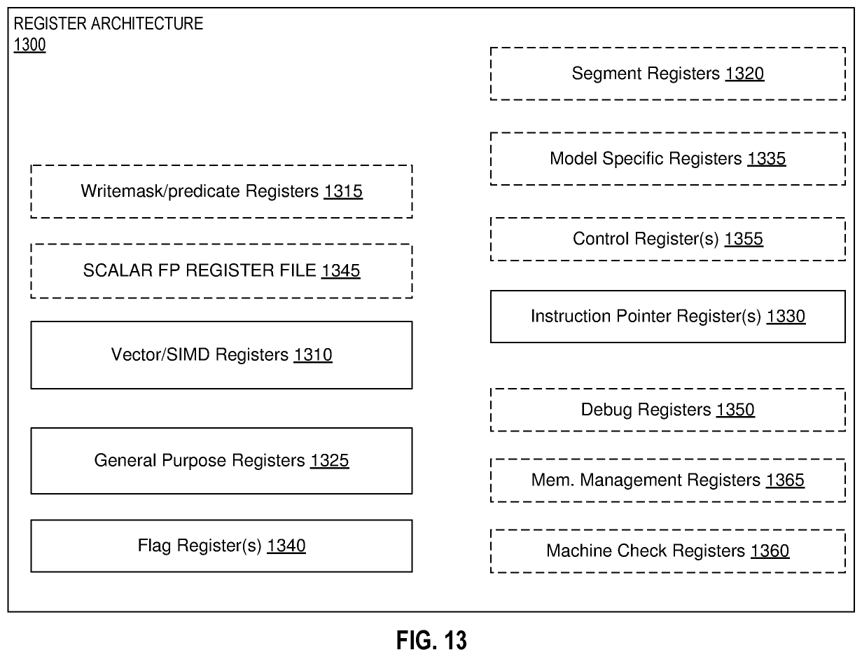

FIG. 13 is a block diagram of a register architecture 1300 according to some examples. As illustrated, the register architecture 1300 includes vector/SIMD registers 1310 that vary from 128-bit to 1,024 bits width. In some examples, the vector/SIMD registers 1310 are physically 512-bits and, depending upon the mapping, only some of the lower bits are used. For example, in some examples, the vector/SIMD registers 1310 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1300 includes writemask/predicate registers 1315. For example, in some examples, there are 8 writemask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1315 corresponds to a data element position of the destination. In other examples, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1300 includes scalar floating-point (FP) register file 1345 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some examples, the one or more flag registers 1340 are called program status and control registers.

Segment registers 1320 contain segment points for use in accessing memory. In some examples, these registers are referenced by the names CS, DS, SS, ES, FS, and GS.

Model specific registers or machine specific registers (MSRs) 1335 control and report on processor performance. Most MSRs 1335 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1360 consist of control, status, and error reporting MSRs that are used to detect and report on hardware errors. Control register(s) 1355 (e.g., CR0-CR4) determine the operating mode of a processor (e.g., processor 470, 480, 438, 415, and/or 500) and the characteristics of a currently executing task. In some examples, MSRs 1335 are a subset of control registers 1355.

One or more instruction pointer register(s) 1330 store an instruction pointer value. Debug registers 1350 control and allow for the monitoring of a processor or core's debugging operations.

Memory (mem) management registers 1365 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1300 may, for example, be used in register file/memory ‘ISAB08, or physical register file(s) circuitry 11 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA

### Graphics Execution Units

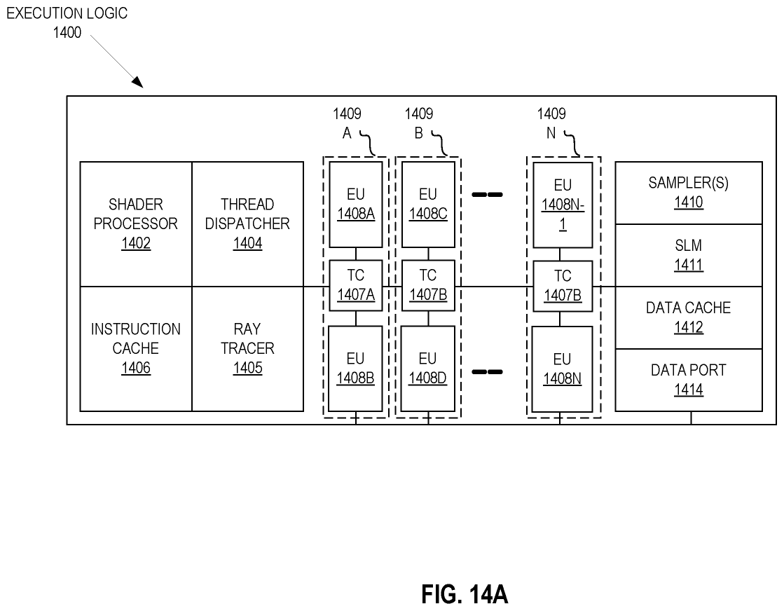

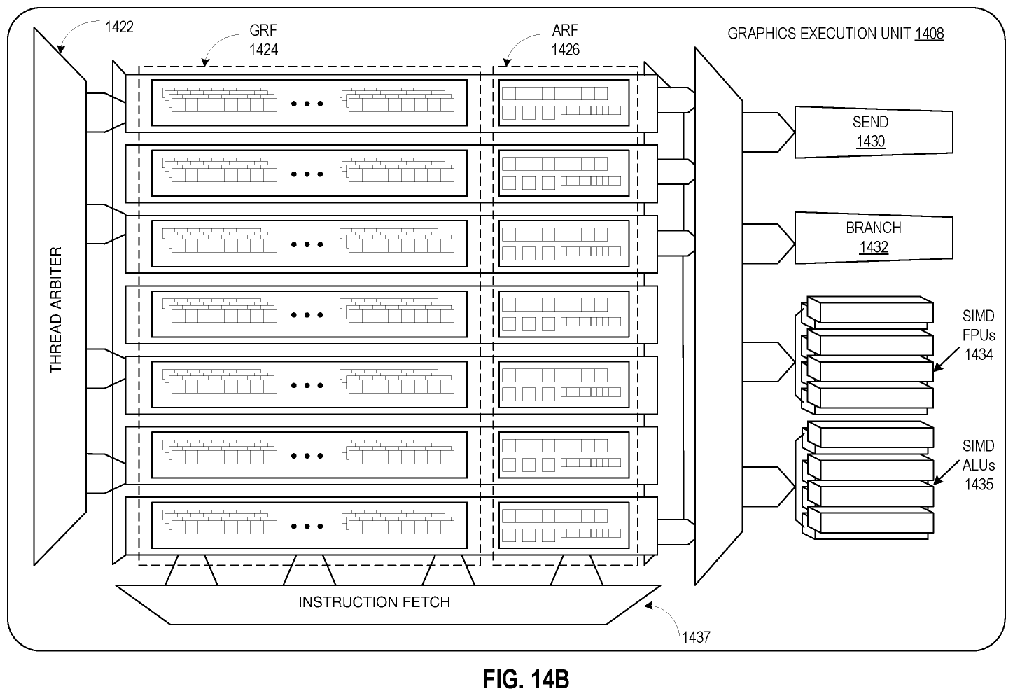

FIGS. 14A-14B illustrate thread execution logic 1400 including an array of processing elements employed in a graphics processor core according to examples described herein. Elements of FIGS. 14A-14B having the same reference numbers (or names) as the elements of any other figure herein can operate or function in any manner similar to that described elsewhere herein, but are not limited to such. FIG. 14A is representative of an execution unit within a general-purpose graphics processor, while FIG. 14B is representative of an execution unit that may be used within a compute accelerator.

As illustrated in FIG. 14A, in some examples thread execution logic 1400 includes a shader processor 1402, a thread dispatcher 1404, instruction cache 1406, a scalable execution unit array including a plurality of execution units 1408A-1408N, a sampler 1410, shared local memory 1411, a data cache 1412, and a data port 1414. In some examples the scalable execution unit array can dynamically scale by enabling or disabling one or more execution units (e.g., any of execution units 1408A, 1408B, 1408C, 1408D, through 1408N−1 and 1408N) based on the computational requirements of a workload. In some examples the included components are interconnected via an interconnect fabric that links to each of the components. In some examples, thread execution logic 1400 includes one or more connections to memory, such as system memory or cache memory, through one or more of instruction cache 1406, data port 1414, sampler 1410, and execution units 1408A-1408N. In some examples, each execution unit (e.g. 1408A) is a stand-alone programmable general-purpose computational unit that is capable of executing multiple simultaneous hardware threads while processing multiple data elements in parallel for each thread. In various examples, the array of execution units 1408A-1408N is scalable to include any number individual execution units.

In some examples, the execution units 1408A-1408N are primarily used to execute shader programs. A shader processor 1402 can process the various shader programs and dispatch execution threads associated with the shader programs via a thread dispatcher 1404. In some examples the thread dispatcher includes logic to arbitrate thread initiation requests from the graphics and media pipelines and instantiate the requested threads on one or more execution unit in the execution units 1408A-1408N. For example, a geometry pipeline can dispatch vertex, tessellation, or geometry shaders to the thread execution logic for processing. In some examples, thread dispatcher 1404 can also process runtime thread spawning requests from the executing shader programs.

In some examples, the execution units 1408A-1408N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 1408A-1408N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 1408A-1408N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 1408A-1408N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 1408A-1408N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused graphics execution unit 1409A-1409N having thread control logic (1407A-1407N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 1409A-1409N includes at least two execution units. For example, fused execution unit 1409A includes a first EU 1408A, second EU 1408B, and thread control logic 1407A that is common to the first EU 1408A and the second EU 1408B. The thread control logic 1407A controls threads executed on the fused graphics execution unit 1409A, allowing each EU within the fused execution units 1409A-1409N to execute using a common instruction pointer register.

One or more internal instruction caches (e.g., 1406) are included in the thread execution logic 1400 to cache thread instructions for the execution units. In some examples, one or more data caches (e.g., 1412) are included to cache thread data during thread execution. Threads executing on the thread execution logic 1400 can also store explicitly managed data in the shared local memory 1411. In some examples, a sampler 1410 is included to provide texture sampling for 3D operations and media sampling for media operations. In some examples, sampler 1410 includes specialized texture or media sampling functionality to process texture or media data during the sampling process before providing the sampled data to an execution unit.

During execution, the graphics and media pipelines send thread initiation requests to thread execution logic 1400 via thread spawning and dispatch logic. Once a group of geometric objects has been processed and rasterized into pixel data, pixel processor logic (e.g., pixel shader logic, fragment shader logic, etc.) within the shader processor 1402 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 1402 then executes an application programming interface (API)-supplied pixel or fragment shader program. To execute the shader program, the shader processor 1402 dispatches threads to an execution unit (e.g., 1408A) via thread dispatcher 1404. In some examples, shader processor 1402 uses texture sampling logic in the sampler 1410 to access texture data in texture maps stored in memory. Arithmetic operations on the texture data and the input geometry data compute pixel color data for each geometric fragment, or discards one or more pixels from further processing.

In some examples, the data port 1414 provides a memory access mechanism for the thread execution logic 1400 to output processed data to memory for further processing on a graphics processor output pipeline. In some examples, the data port 1414 includes or couples to one or more cache memories (e.g., data cache 1412) to cache data for memory access via the data port.

In some examples, the execution logic 1400 can also include a ray tracer 1405 that can provide ray tracing acceleration functionality. The ray tracer 1405 can support a ray tracing instruction set that includes instructions/functions for ray generation.

FIG. 14B illustrates exemplary internal details of an execution unit 1408, according to examples. A graphics execution unit 1408 can include an instruction fetch unit 1437, a general register file array (GRF) 1424, an architectural register file array (ARF) 1426, a thread arbiter 1422, a send unit 1430, a branch unit 1432, a set of SIMD floating point units (FPUs) 1434, and in some examples a set of dedicated integer SIMD ALUs 1435. The GRF 1424 and ARF 1426 includes the set of general register files and architecture register files associated with each simultaneous hardware thread that may be active in the graphics execution unit 1408. In some examples, per thread architectural state is maintained in the ARF 1426, while data used during thread execution is stored in the GRF 1424. The execution state of each thread, including the instruction pointers for each thread, can be held in thread-specific registers in the ARF 1426.

In some examples the graphics execution unit 1408 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 1408 is not limited to the number of hardware threads, and multiple logical threads can be assigned to each hardware thread.

In some examples, the graphics execution unit 1408 can co-issue multiple instructions, which may each be different instructions. The thread arbiter 1422 of the graphics execution unit thread 1408 can dispatch the instructions to one of the send unit 1430, branch unit 1432, or SIMD FPU(s) 1434 for execution. Each execution thread can access 128 general-purpose registers within the GRF 1424, where each register can store 32 bytes, accessible as a SIMD 8-element vector of 32-bit data elements. In some examples, each execution unit thread has access to 4 Kbytes within the GRF 1424, although examples are not so limited, and greater or fewer register resources may be provided in other examples. In some examples the graphics execution unit 1408 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 1424 can store a total of 28 Kbytes. Where 16 threads may access 4 Kbytes, the GRF 1424 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 1430. In some examples, branch instructions are dispatched to a dedicated branch unit 1432 to facilitate SIMD divergence and eventual convergence.

In some examples the graphics execution unit 1408 includes one or more SIMD FPU(s) 1434 to perform floating-point operations. In some examples, the FPU(s) 1434 also support integer computation. In some examples the FPU(s) 1434 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 1435 are also present, and may be specifically optimized to perform operations associated with machine learning computations.

In some examples, arrays of multiple instances of the graphics execution unit 1408 can be instantiated in a graphics sub-core grouping (e.g., a sub-slice). For scalability, product architects can choose the exact number of execution units per sub-core grouping. In some examples the execution unit 1408 can execute instructions across a plurality of execution channels. In a further example, each thread executed on the graphics execution unit 1408 is executed on a different channel.

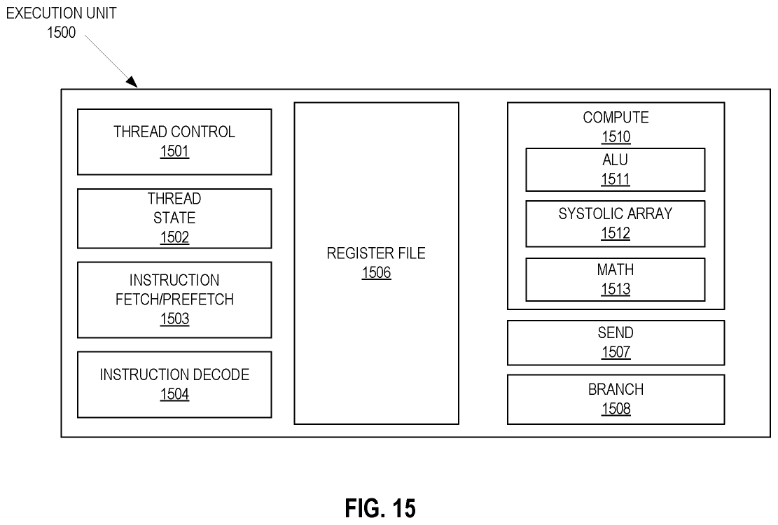

FIG. 15 illustrates an additional execution unit 1500, according to an example. In some examples, the execution unit 1500 includes a thread control unit 1501, a thread state unit 1502, an instruction fetch/prefetch unit 1503, and an instruction decode unit 1504. The execution unit 1500 additionally includes a register file 1506 that stores registers that can be assigned to hardware threads within the execution unit. The execution unit 1500 additionally includes a send unit 1507 and a branch unit 1508. In some examples, the send unit 1507 and branch unit 1508 can operate similarly as the send unit 1430 and a branch unit 1432 of the graphics execution unit 1408 of FIG. 14B.

The execution unit 1500 also includes a compute unit 1510 that includes multiple different types of functional units. In some examples the compute unit 1510 includes an ALU unit 1511 that includes an array of arithmetic logic units. The ALU unit 1511 can be configured to perform 64-bit, 32-bit, and 16-bit integer and floating point operations. Integer and floating point operations may be performed simultaneously. The compute unit 1510 can also include a systolic array 1512, and a math unit 1513. The systolic array 1512 includes a W wide and D deep network of data processing units that can be used to perform vector or other data-parallel operations in a systolic manner. In some examples the systolic array 1512 can be configured to perform matrix operations, such as matrix dot product operations. In some examples the systolic array 1512 support 16-bit floating point operations, as well as 8-bit and 4-bit integer operations. In some examples the systolic array 1512 can be configured to accelerate machine learning operations. In such examples, the systolic array 1512 can be configured with support for the bfloat 16-bit floating point format. In some examples, a math unit 1513 can be included to perform a specific subset of mathematical operations in an efficient and lower-power manner than the ALU unit 1511. The math unit 1513 can include a variant of math logic that may be found in shared function logic of a graphics processing engine provided by other examples. In some examples the math unit 1513 can be configured to perform 32-bit and 64-bit floating point operations.

The thread control unit 1501 includes logic to control the execution of threads within the execution unit. The thread control unit 1501 can include thread arbitration logic to start, stop, and preempt execution of threads within the execution unit 1500. The thread state unit 1502 can be used to store thread state for threads assigned to execute on the execution unit 1500. Storing the thread state within the execution unit 1500 enables the rapid pre-emption of threads when those threads become blocked or idle. The instruction fetch/prefetch unit 1503 can fetch instructions from an instruction cache of higher level execution logic (e.g., instruction cache 1406 as in FIG. 14A). The instruction fetch/prefetch unit 1503 can also issue prefetch requests for instructions to be loaded into the instruction cache based on an analysis of currently executing threads. The instruction decode unit 1504 can be used to decode instructions to be executed by the compute units. In some examples, the instruction decode unit 1504 can be used as a secondary decoder to decode complex instructions into constituent micro-operations.

The execution unit 1500 additionally includes a register file 1506 that can be used by hardware threads executing on the execution unit 1500. Registers in the register file 1506 can be divided across the logic used to execute multiple simultaneous threads within the compute unit 1510 of the execution unit 1500. The number of logical threads that may be executed by the execution unit 1500 is not limited to the number of hardware threads, and multiple logical threads can be assigned to each hardware thread. The size of the register file 1506 can vary across examples based on the number of supported hardware threads. In some examples, register renaming may be used to dynamically allocate registers to hardware threads.

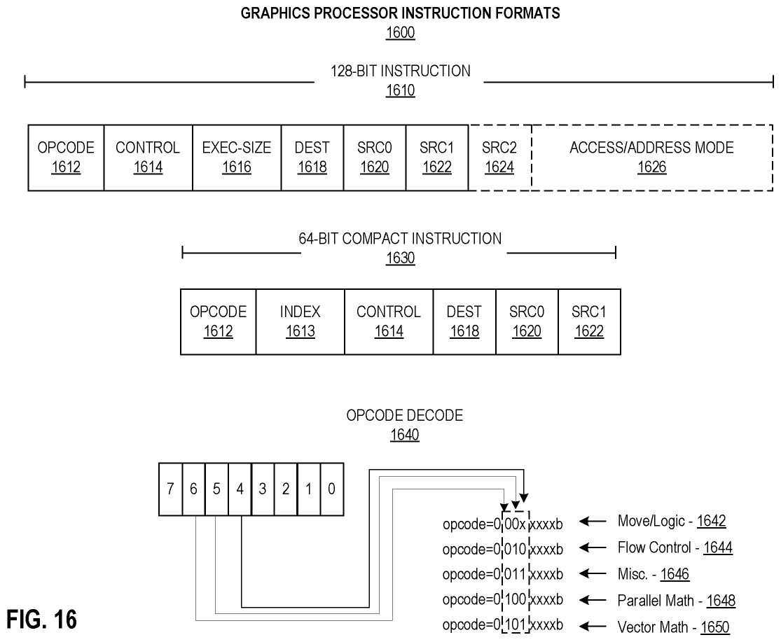

FIG. 16 is a block diagram illustrating a graphics processor instruction formats 1600 according to some examples. In one or more example, the graphics processor execution units support an instruction set having instructions in multiple formats. The solid lined boxes illustrate the components that are generally included in an execution unit instruction, while the dashed lines include components that are optional or that are only included in a sub-set of the instructions. In some examples, instruction format 1600 described and illustrated are macroinstructions, in that they are instructions supplied to the execution unit, as opposed to micro-operations resulting from instruction decode once the instruction is processed.

In some examples, the graphics processor execution units natively support instructions in a 128-bit instruction format 1610. A 64-bit compacted instruction format 1630 is available for some instructions based on the selected instruction, instruction options, and number of operands. The native 128-bit instruction format 1610 provides access to all instruction options, while some options and operations are restricted in the 64-bit compacted format 1630. The native instructions available in the 64-bit compacted format 1630 vary by example. In some examples, the instruction is compacted in part using a set of index values in an index field 1613. The execution unit hardware references a set of compaction tables based on the index values and uses the compaction table outputs to reconstruct a native instruction in the 128-bit instruction format 1610. Other sizes and formats of instruction can be used.

For each format, instruction opcode 1612 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some examples, instruction control field 1614 enables control over certain execution options, such as channels selection (e.g., predication) and data channel order (e.g., swizzle). For instructions in the 128-bit instruction format 1610 an exec-size field 1616 limits the number of data channels that will be executed in parallel. In some examples, exec-size field 1616 is not available for use in the 64-bit compact instruction format 1630.

Some execution unit instructions have up to three operands including two source operands, src0 1620, src1 1622, and one destination 1618. In some examples, the execution units support dual destination instructions, where one of the destinations is implied. Data manipulation instructions can have a third source operand (e.g., SRC2 1624), where the instruction opcode 1612 determines the number of source operands. An instruction's last source operand can be an immediate (e.g., hard-coded) value passed with the instruction.

In some examples, the 128-bit instruction format 1610 includes an access/address mode field 1626 specifying, for example, whether direct register addressing mode or indirect register addressing mode is used. When direct register addressing mode is used, the register address of one or more operands is directly provided by bits in the instruction.

In some examples, the 128-bit instruction format 1610 includes an access/address mode field 1626, which specifies an address mode and/or an access mode for the instruction. In some examples the access mode is used to define a data access alignment for the instruction. Some examples support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In some examples, the address mode portion of the access/address mode field 1626 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some examples instructions are grouped based on opcode 1612 bit-fields to simplify Opcode decode 1640. For an 8-bit opcode, bits 4, 5, and 6 allow the execution unit to determine the type of opcode. The precise opcode grouping shown is merely an example. In some examples, a move and logic opcode group 1642 includes data movement and logic instructions (e.g., move (mov), compare (cmp)). In some examples, move and logic opcode group 1642 shares the five most significant bits (MSB), where move (mov) instructions are in the form of 0000xxxxb and logic instructions are in the form of 0001xxxxb. A flow control instruction group 1644 (e.g., call, jump (jmp) includes instructions in the form of 0010xxxxb (e.g., 0x20). A miscellaneous instruction group 1646 includes a mix of instructions, including synchronization instructions (e.g., wait, send) in the form of 0011xxxxb (e.g., 0x30). A parallel math instruction group 1648 includes component-wise arithmetic instructions (e.g., add, multiply (mul)) in the form of 0100xxxxb (e.g., 0x40). The parallel math instruction group 1648 performs the arithmetic operations in parallel across data channels. The vector math group 1650 includes arithmetic instructions (e.g., dp4) in the form of 0101xxxxb (e.g., 0x50). The vector math group performs arithmetic such as dot product calculations on vector operands. The illustrated opcode decode 1640, in some examples, can be used to determine which portion of an execution unit will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

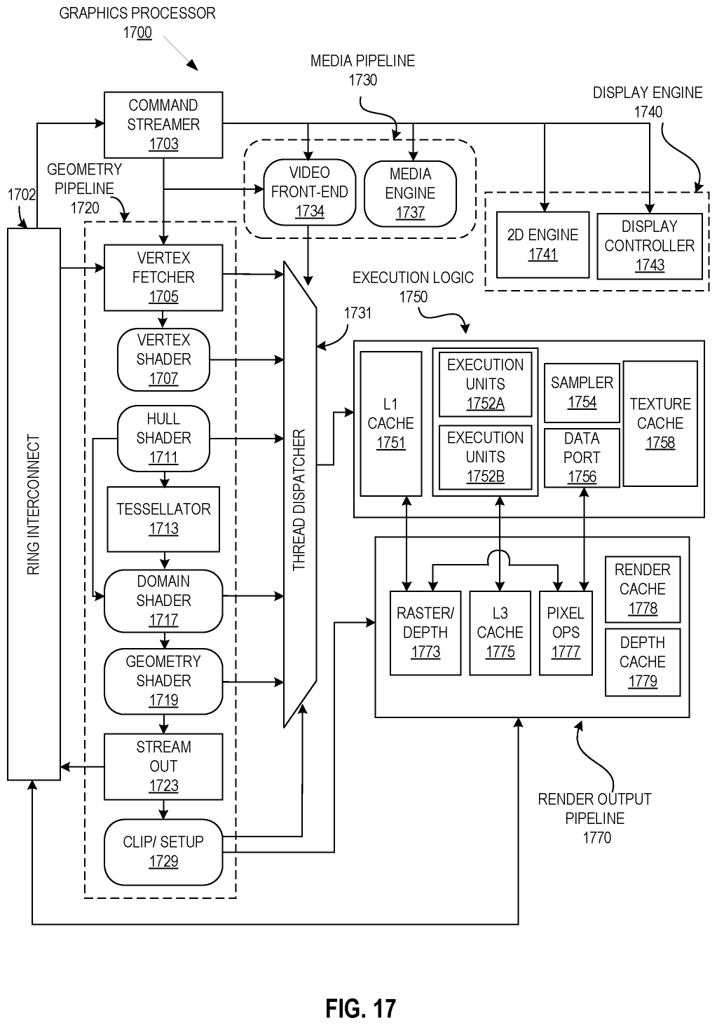

FIG. 17 is a block diagram of another example of a graphics processor 1700. Elements of FIG. 17 having the same reference numbers (or names) as the elements of any other figure herein can operate or function in any manner similar to that described elsewhere herein, but are not limited to such.

In some examples, graphics processor 1700 includes a geometry pipeline 1720, a media pipeline 1730, a display engine 1740, thread execution logic 1750, and a render output pipeline 1770. In some examples, graphics processor 1700 is a graphics processor within a multi-core processing system that includes one or more general-purpose processing cores. The graphics processor is controlled by register writes to one or more control registers (not shown) or via commands issued to graphics processor 1700 via a ring interconnect 1702. In some examples, ring interconnect 1702 couples graphics processor 1700 to other processing components, such as other graphics processors or general-purpose processors. Commands from ring interconnect 1702 are interpreted by a command streamer 1703, which supplies instructions to individual components of the geometry pipeline 1720 or the media pipeline 1730.

In some examples, command streamer 1703 directs the operation of a vertex fetcher 1705 that reads vertex data from memory and executes vertex-processing commands provided by command streamer 1703. In some examples, vertex fetcher 1705 provides vertex data to a vertex shader 1707, which performs coordinate space transformation and lighting operations to each vertex. In some examples, vertex fetcher 1705 and vertex shader 1707 execute vertex-processing instructions by dispatching execution threads to execution units 1752A-1752B via a thread dispatcher 1731.

In some examples, execution units 1752A-1752B are an array of vector processors having an instruction set for performing graphics and media operations. In some examples, execution units 1752A-1752B have an attached L1 cache 1751 that is specific for each array or shared between the arrays. The cache can be configured as a data cache, an instruction cache, or a single cache that is partitioned to contain data and instructions in different partitions.

In some examples, geometry pipeline 1720 includes tessellation components to perform hardware-accelerated tessellation of 3D objects. In some examples, a programmable hull shader 1711 configures the tessellation operations. A programmable domain shader 1717 provides back-end evaluation of tessellation output. A tessellator 1713 operates at the direction of hull shader 1711 and contains special purpose logic to generate a set of detailed geometric objects based on a coarse geometric model that is provided as input to geometry pipeline 1720. In some examples, if tessellation is not used, tessellation components (e.g., hull shader 1711, tessellator 1713, and domain shader 1717) can be bypassed.

In some examples, complete geometric objects can be processed by a geometry shader 1719 via one or more threads dispatched to execution units 1752A-1752B, or can proceed directly to the clipper 1729. In some examples, the geometry shader operates on entire geometric objects, rather than vertices or patches of vertices as in previous stages of the graphics pipeline. If the tessellation is disabled the geometry shader 1719 receives input from the vertex shader 1707. In some examples, geometry shader 1719 is programmable by a geometry shader program to perform geometry tessellation if the tessellation units are disabled.

Before rasterization, a clipper 1729 processes vertex data. The clipper 1729 may be a fixed function clipper or a programmable clipper having clipping and geometry shader functions. In some examples, a rasterizer and depth test component 1773 in the render output pipeline 1770 dispatches pixel shaders to convert the geometric objects into per pixel representations. In some examples, pixel shader logic is included in thread execution logic 1750. In some examples, an application can bypass the rasterizer and depth test component 1773 and access un-rasterized vertex data via a stream out unit 1723.

The graphics processor 1700 has an interconnect bus, interconnect fabric, or some other interconnect mechanism that allows data and message passing amongst the major components of the processor. In some examples, execution units 1752A-1752B and associated logic units (e.g., L1 cache 1751, sampler 1754, texture cache 1758, etc.) interconnect via a data port 1756 to perform memory access and communicate with render output pipeline components of the processor. In some examples, sampler 1754, caches 1751, 1758 and execution units 1752A-1752B each have separate memory access paths. In some examples the texture cache 1758 can also be configured as a sampler cache.

In some examples, render output pipeline 1770 contains a rasterizer and depth test component 1773 that converts vertex-based objects into an associated pixel-based representation. In some examples, the rasterizer logic includes a windower/masker unit to perform fixed function triangle and line rasterization. An associated render cache 1778 and depth cache 1779 are also available in some examples. A pixel operations component 1777 performs pixel-based operations on the data, though in some instances, pixel operations associated with 2D operations (e.g. bit block image transfers with blending) are performed by the 2D engine 1741, or substituted at display time by the display controller 1743 using overlay display planes. In some examples, a shared L3 cache 1775 is available to all graphics components, allowing the sharing of data without the use of main system memory.

In some examples, media pipeline 1730 includes a media engine 1737 and a video front-end 1734. In some examples, video front-end 1734 receives pipeline commands from the command streamer 1703. In some examples, media pipeline 1730 includes a separate command streamer. In some examples, video front-end 1734 processes media commands before sending the command to the media engine 1737. In some examples, media engine 1737 includes thread spawning functionality to spawn threads for dispatch to thread execution logic 1750 via thread dispatcher 1731.

In some examples, graphics processor 1700 includes a display engine 1740. In some examples, display engine 1740 is external to graphics processor 1700 and couples with the graphics processor via the ring interconnect 1702, or some other interconnect bus or fabric. In some examples, display engine 1740 includes a 2D engine 1741 and a display controller 1743. In some examples, display engine 1740 contains special purpose logic capable of operating independently of the 3D pipeline. In some examples, display controller 1743 couples with a display device (not shown), which may be a system integrated display device, as in a laptop computer, or an external display device attached via a display device connector.

In some examples, the geometry pipeline 1720 and media pipeline 1730 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

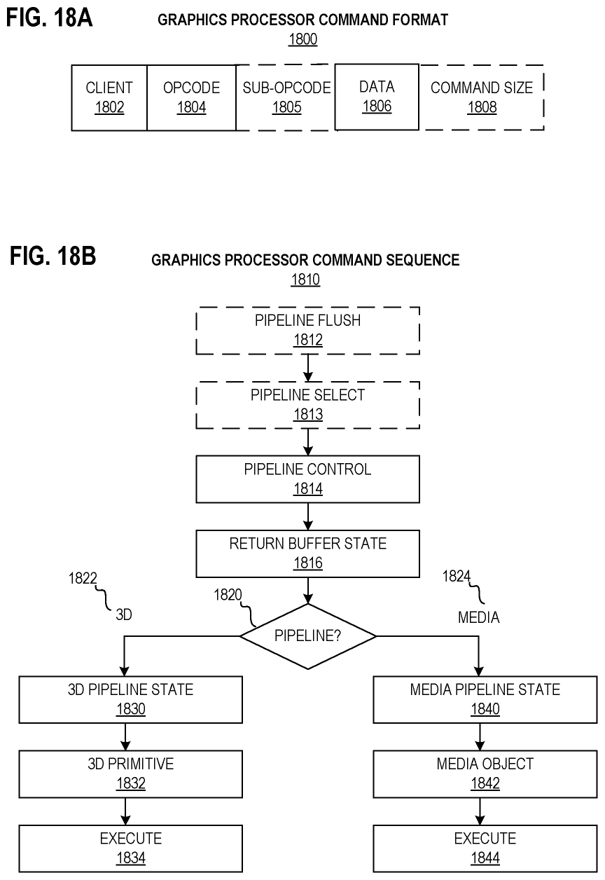

FIG. 18A is a block diagram illustrating a graphics processor command format 1800 according to some examples. FIG. 18B is a block diagram illustrating a graphics processor command sequence 1810 according to an example. The solid lined boxes in FIG. 18A illustrate the components that are generally included in a graphics command while the dashed lines include components that are optional or that are only included in a sub-set of the graphics commands. The graphics processor command format 1800 of FIG. 18A includes data fields to identify a client 1802, a command operation code (opcode) 1804, and data 1806 for the command. A sub-opcode 1805 and a command size 1808 are also included in some commands.

In some examples, client 1802 specifies the client unit of the graphics device that processes the command data. In some examples, a graphics processor command parser examines the client field of each command to condition the further processing of the command and route the command data to the appropriate client unit. In some examples, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 1804 and, if present, sub-opcode 1805 to determine the operation to perform. The client unit performs the command using information in data field 1806. For some commands an explicit command size 1808 is expected to specify the size of the command. In some examples, the command parser automatically determines the size of at least some of the commands based on the command opcode. In some examples commands are aligned via multiples of a double word. Other command formats can be used.

The flow diagram in FIG. 18B illustrates a graphics processor command sequence 1810. In some examples, software or firmware of a data processing system that features an example of a graphics processor uses a version of the command sequence shown to set up, execute, and terminate a set of graphics operations. A sample command sequence is shown and described for purposes of example only as examples are not limited to these specific commands or to this command sequence. Moreover, the commands may be issued as batch of commands in a command sequence, such that the graphics processor will process the sequence of commands in at least partially concurrence.

In some examples, the graphics processor command sequence 1810 may begin with a pipeline flush command 1812 to cause any active graphics pipeline to complete the currently pending commands for the pipeline. In some examples, the 3D pipeline 1822 and the media pipeline 1824 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some examples, pipeline flush command 1812 can be used for pipeline synchronization or before placing the graphics processor into a low power state.

In some examples, a pipeline select command 1813 is used when a command sequence requires the graphics processor to explicitly switch between pipelines. In some examples, a pipeline select command 1813 is required only once within an execution context before issuing pipeline commands unless the context is to issue commands for both pipelines. In some examples, a pipeline flush command 1812 is required immediately before a pipeline switch via the pipeline select command 1813.

In some examples, a pipeline control command 1814 configures a graphics pipeline for operation and is used to program the 3D pipeline 1822 and the media pipeline 1824. In some examples, pipeline control command 1814 configures the pipeline state for the active pipeline. In some examples, the pipeline control command 1814 is used for pipeline synchronization and to clear data from one or more cache memories within the active pipeline before processing a batch of commands.

In some examples, return buffer state commands 1816 are used to configure a set of return buffers for the respective pipelines to write data. Some pipeline operations require the allocation, selection, or configuration of one or more return buffers into which the operations write intermediate data during processing. In some examples, the graphics processor also uses one or more return buffers to store output data and to perform cross thread communication. In some examples, the return buffer state includes selecting the size and number of return buffers to use for a set of pipeline operations.

The remaining commands in the command sequence differ based on the active pipeline for operations. Based on a pipeline determination 1820, the command sequence is tailored to the 3D pipeline 1822 beginning with the 3D pipeline state 1830 or the media pipeline 1824 beginning at the media pipeline state 1840.

The commands to configure the 3D pipeline state 1830 include 3D state setting commands for vertex buffer state, vertex element state, constant color state, depth buffer state, and other state variables that are to be configured before 3D primitive commands are processed. The values of these commands are determined at least in part based on the particular 3D API in use. In some examples, 3D pipeline state 1830 commands are also able to selectively disable or bypass certain pipeline elements if those elements will not be used.

In some examples, 3D primitive 1832 command is used to submit 3D primitives to be processed by the 3D pipeline. Commands and associated parameters that are passed to the graphics processor via the 3D primitive 1832 command are forwarded to the vertex fetch function in the graphics pipeline. The vertex fetch function uses the 3D primitive 1832 command data to generate vertex data structures. The vertex data structures are stored in one or more return buffers. In some examples, 3D primitive 1832 command is used to perform vertex operations on 3D primitives via vertex shaders. To process vertex shaders, 3D pipeline 1822 dispatches shader execution threads to graphics processor execution units.

In some examples, 3D pipeline 1822 is triggered via an execute 1834 command or event. In some examples, a register write triggers command execution. In some examples execution is triggered via a ‘go’ or ‘kick’ command in the command sequence. In some examples, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some examples, the graphics processor command sequence 1810 follows the media pipeline 1824 path when performing media operations. In general, the specific use and manner of programming for the media pipeline 1824 depends on the media or compute operations to be performed. Specific media decode operations may be offloaded to the media pipeline during media decode. In some examples, the media pipeline can also be bypassed and media decode can be performed in whole or in part using resources provided by one or more general-purpose processing cores. In some examples, the media pipeline also includes elements for general-purpose graphics processor unit (GPGPU) operations, where the graphics processor is used to perform SIMD vector operations using computational shader programs that are not explicitly related to the rendering of graphics primitives.

In some examples, media pipeline 1824 is configured in a similar manner as the 3D pipeline 1822. A set of commands to configure the media pipeline state 1840 are dispatched or placed into a command queue before the media object commands 1842. In some examples, commands for the media pipeline state 1840 include data to configure the media pipeline elements that will be used to process the media objects. This includes data to configure the video decode and video encode logic within the media pipeline, such as encode or decode format. In some examples, commands for the media pipeline state 1840 also support the use of one or more pointers to “indirect” state elements that contain a batch of state settings.

In some examples, media object commands 1842 supply pointers to media objects for processing by the media pipeline. The media objects include memory buffers containing video data to be processed. In some examples, all media pipeline states must be valid before issuing a media object command 1842. Once the pipeline state is configured and media object commands 1842 are queued, the media pipeline 1824 is triggered via an execute command 1844 or an equivalent execute event (e.g., register write). Output from media pipeline 1824 may then be post processed by operations provided by the 3D pipeline 1822 or the media pipeline 1824. In some examples, GPGPU operations are configured and executed in a similar manner as media operations.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

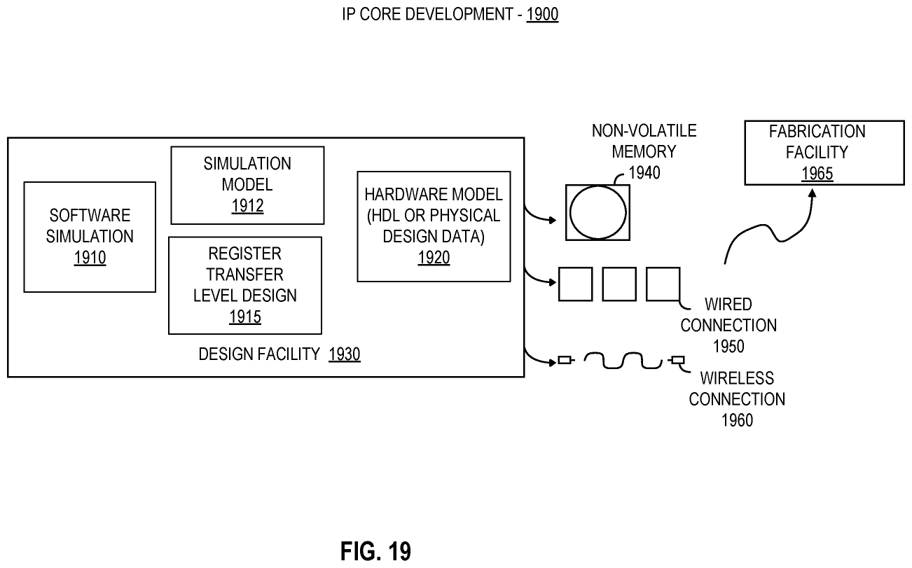

FIG. 19 is a block diagram illustrating an IP core development system 1900 that may be used to manufacture an integrated circuit to perform operations according to some examples. The IP core development system 1900 may be used to generate modular, re-usable designs that can be incorporated into a larger design or used to construct an entire integrated circuit (e.g., an SOC integrated circuit). A design facility 1930 can generate a software simulation 1910 of an IP core design in a high-level programming language (e.g., C/C++). The software simulation 1910 can be used to design, test, and verify the behavior of the IP core using a simulation model 1912. The simulation model 1912 may include functional, behavioral, and/or timing simulations. A register transfer level (RTL) design 1915 can then be created or synthesized from the simulation model 1912. The RTL design 1915 is an abstraction of the behavior of the integrated circuit that models the flow of digital signals between hardware registers, including the associated logic performed using the modeled digital signals. In addition to an RTL design 1915, lower-level designs at the logic level or transistor level may also be created, designed, or synthesized. Thus, the particular details of the initial design and simulation may vary.

The RTL design 1915 or equivalent may be further synthesized by the design facility into a hardware model 1920, which may be in a hardware description language (HDL), or some other representation of physical design data. The HDL may be further simulated or tested to verify the IP core design. The IP core design can be stored for delivery to a fabrication facility 1965 using non-volatile memory 1940 (e.g., hard disk, flash memory, or any non-volatile storage medium). Alternatively, the IP core design may be transmitted (e.g., via the Internet) over a wired connection 1950 or wireless connection 1960. The fabrication facility 1965 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:
1. An apparatus comprising:
   a pipeline to support a first thread and a runahead thread, wherein the pipeline comprises:
      rename circuitry to rename architectural sources and destination of micro-operations of a thread,
      allocation circuitry to allocation resources to micro-operations of a thread,
      a reservation station to dispatch micro-operations of a thread to execution resources,
      execution resources to perform the micro-operations of a thread, and
      retirement circuitry to track when micro-operations are ready to retire;
   critical branch table to store retiring micro-operations of the first thread that are mispredicted;
   chain construction buffer to store all retiring micro-operations of the first thread;
   a critical micro-operation cache to store micro-operation of the chain construction buffer that have been marked critical; and
   runahead thread fetch unit to pre-compute a branch direction for a critical branch of the critical micro-operation cache to be used in the runahead thread.
2. The apparatus of example 1, wherein each entry in the chain construction buffer includes a single micro-operation, a logical instruction pointer, source and destination information, and an indication of if the micro-operation is critical.
3. The apparatus of any of examples 1-2, further comprising:
   a shadow register alias table for use by the runahead thread.
4. The apparatus of any of examples 1-3, further comprising:
   an inflight branch queue to store branch information for branches of the first thread.
5. The apparatus of any of examples 1-4, further comprising:
   a branch verification queue store branch information for branches of the runahead thread.
6. The apparatus of any of examples 1-5, further comprising:
   verify runahead execution circuitry to verify branches of the first thread and runahead thread to determine when the runahead thread is to be terminated.
7. The apparatus of any of examples 1-6, wherein an early branch clear is to be issued when the runahead thread is correct and the first thread has a branch mispredict.
8. The apparatus of any of examples 1-7, wherein a branch clear is to be issued when a branch prediction for runahead thread is incorrect and a branch prediction the first thread is also incorrect.
9. The apparatus of any of examples 1-8, wherein no branch clear is to be issued when the runahead thread is correct and the first thread has a branch mispredict.
10. The apparatus of any of examples 1-9, wherein a first branch clear is to be issued when a branch prediction the first thread is correct and a second branch clear is to be issued when a branch prediction the runahead thread is incorrect.
11. The apparatus of any of examples 1-10, further comprising:
   one or more branch prediction units to predict one or more branches of the first thread.
12. A system comprising:
   memory to store a first thread to be executed;
   a first processor core; and
   a second processor core, wherein an out-of-order pipeline of at least one of the first and the second processor cores is to support execution of the first thread and a runahead thread, wherein the pipeline comprises:
      rename circuitry to rename architectural sources and destination of micro-operations of a thread,
      allocation circuitry to allocation resources to micro-operations of a thread,
      a reservation station to dispatch micro-operations of a thread to execution resources,
      execution resources to perform the micro-operations of a thread, and
      retirement circuitry to track when micro-operations are ready to retire;
   critical branch table to store retiring micro-operations of the first thread that are mispredicted;
   chain construction buffer to store all retiring micro-operations of the first thread;
   a critical micro-operation cache to store micro-operation of the chain construction buffer that have been marked critical; and
   runahead thread fetch unit to pre-compute a branch direction for a critical branch of the critical micro-operation cache to be used in the runahead thread.
13. The system of example 12, wherein each entry in the chain construction buffer includes a single micro-operation, a logical instruction pointer, source and destination information, and an indication of if the micro-operation is critical.
14. The system of any of examples 12-13, further comprising:
   a shadow register alias table for use by the runahead thread.
15. The system of any of examples 12-14, further comprising:
   an inflight branch queue to store branch information for branches of the first thread.
16. The system of any of examples 12-15, further comprising:
   a branch verification queue store branch information for branches of the runahead thread.
17. The system of any of examples 12-16, further comprising:
   verify runahead execution circuitry to verify branches of the first thread and runahead thread to determine when the runahead thread is to be terminated.
18. The system of any of examples 12-17, wherein an early branch clear indication is to be issued when the runahead thread is correct and the first thread has a branch mispredict.
19. The system of any of examples 12-18, wherein a branch clear indication is to be issued when a branch prediction for runahead thread is incorrect and a branch prediction the first thread is also incorrect.
20. The system of any of examples 12-19, wherein a first branch clear indication is to be issued when a branch prediction the first thread is correct and a second branch clear indication is to be issued when a branch prediction the runahead thread is incorrect.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a pipeline to support a first thread and a runahead thread, wherein the pipeline comprises:
rename circuitry to rename architectural sources and destinations of micro-operations of a thread,
allocation circuitry to allocate resources to micro-operations of a thread,
a reservation station to dispatch micro-operations of a thread to execution resources,
execution resources to perform the micro-operations of a thread, and
retirement circuitry to track when micro-operations are ready to retire;
memory to store a critical branch data structure to store retiring micro-operations of the first thread that are mispredicted;
a chain construction buffer to store all retiring micro-operations of the first thread;
a critical micro-operation cache to store micro-operations of the chain construction buffer that have been marked critical; and
a runahead thread fetch unit to pre-compute a branch direction for a critical branch of the critical micro-operation cache to be used in the runahead thread.

2. The apparatus of claim 1, wherein each entry in the chain construction buffer includes a single micro-operation, a logical instruction pointer, source and destination information, and an indication of if the micro-operation is critical.

3. The apparatus of claim 1, further comprising:
a shadow register alias table for use by the runahead thread.

4. The apparatus of claim 1, further comprising:
an inflight branch queue to store branch information for branches of the first thread.

5. The apparatus of claim 1, further comprising:
a branch verification queue store branch information for branches of the runahead thread.

6. The apparatus of claim 1, further comprising:
verify runahead execution circuitry to verify branches of the first thread and runahead thread to determine when the runahead thread is to be terminated.

7. The apparatus of claim 1, wherein an early branch clear is to be issued when the runahead thread is correct and the first thread has a branch mispredict.

8. The apparatus of claim 1, wherein a branch clear is to be issued when a branch prediction for runahead thread is incorrect and a branch prediction the first thread is also incorrect.

9. The apparatus of claim 1, wherein no branch clear is to be issued when the runahead thread is correct and the first thread has a branch mispredict.

10. The apparatus of claim 1, wherein a first branch clear is to be issued when a branch prediction the first thread is correct and a second branch clear is to be issued when a branch prediction the runahead thread is incorrect.

11. The apparatus of claim 1, further comprising:
one or more branch prediction units to predict one or more branches of the first thread.

12. A system comprising:
memory to store a first thread to be executed;
a first processor core; and
a second processor core, wherein an out-of-order pipeline of at least one of the first and the second processor cores is to support execution of the first thread and a runahead thread, wherein the pipeline comprises:
rename circuitry to rename architectural sources and destination of micro-operations of a thread,
allocation circuitry to allocate resources to the micro-operations of a thread,
a reservation station to dispatch micro-operations of a thread to execution resources,
execution resources to perform the micro-operations of a thread, and
retirement circuitry to track when micro-operations are ready to retire;
memory to store a critical branch data structure to store retiring micro-operations of the first thread that are mispredicted;
a chain construction buffer to store all retiring micro-operations of the first thread;
a critical micro-operation cache to store micro-operation of the chain construction buffer that have been marked critical; and
a runahead thread fetch unit to pre-compute a branch direction for a critical branch of the critical micro-operation cache to be used in the runahead thread.

13. The system of claim 12, wherein each entry in the chain construction buffer includes a single micro-operation, a logical instruction pointer, source and destination information, and an indication of if the micro-operation is critical.

14. The system of claim 12, further comprising:
a shadow register alias table for use by the runahead thread.

15. The system of claim 12, further comprising:
an inflight branch queue to store branch information for branches of the first thread.

16. The system of claim 12, further comprising:
a branch verification queue store branch information for branches of the runahead thread.

17. The system of claim 12, further comprising:
verify runahead execution circuitry to verify branches of the first thread and runahead thread to determine when the runahead thread is to be terminated.

18. The system of claim 12, wherein an early branch clear indication is to be issued when the runahead thread is correct and the first thread has a branch mispredict.

19. The system of claim 12, wherein a branch clear indication is to be issued when a branch prediction for runahead thread is incorrect and a branch prediction the first thread is also incorrect.

20. The system of claim 12, wherein a first branch clear indication is to be issued when a branch prediction the first thread is correct and a second branch clear indication is to be issued when a branch prediction the runahead thread is incorrect.
